(19) United States
(12) Patent Application Publication
(10) Pub. No.: US 2024/0187648 A1
(43) Pub. Date: Jun. 6, 2024

(54) Coding Vertex Information of a Point Cloud

(71) Applicant: Comcast Cable Communications, LLC, Philadelphia, PA (US)

(72) Inventor: Sébastien Lasserre, Thorigné-Fouillard (FR)

(21) Appl. No.: 18/529,614

(22) Filed: Dec. 5, 2023

Related U.S. Application Data
(60) Provisional application No. 63/430,305, filed on Dec. 5, 2022.

(51) Int. Cl. H04N 19/597

(52) U.S. Cl. CPC H04N 19/597

(57) ABSTRACT

One or more methods, apparatuses, computer-readable storage mediums, and systems for entropy coding vertex information of an edge in a voxelized space of a point cloud are disclosed. Symbols of a neighborhood configuration of a current edge may be determined based on one or more already coded edges. The already coded edges may be selected from a spatial topology of edges or its subset. An index indicating an appropriate context or probability model for a given occupancy configuration for a neighborhood of a current edge may be retrieved.

### CROSS-REFERENCE TO RELATED APPLICATIONS

This application claims the benefit of U.S. Provisional Application No. 63/430,305 filed on Dec. 5, 2022. The above referenced application is hereby incorporated by reference in its entirety.

### BACKGROUND

An object or scene may be described using volumetric visual data consisting of a series of points. The points may be stored as a point cloud format that includes a collection of points in three-dimensional space. As point clouds can get quite large in data size, transmitting and processing point cloud data may need a data compression scheme that is specifically designed with respect to the unique characteristics of point clod data.

### SUMMARY

The following summary presents a simplified summary of certain features. The summary is not an extensive overview and is not intended to identify key or critical elements.

Coding (e.g., encoding, decoding) may be used to compress and decompress a point cloud frame or sequence for efficient storage and transmission. To entropy code a current cuboid, a coder may use a spatial neighborhood of cuboids relative to the current cuboid. A Triangle Soup (TriSoup) scheme may be used, for such point cloud geometries, to represent a vertex and its position on a TriSoup edge. A linear combination based on spatial positions of the neighbor TriSoup edges relative to the current TriSoup edge may be used to improve and increase the correlation between the neighborhood configuration and the vertex information of the current edge. The improved correlation may allow the vertex information of the current TriSoup edge to be more effectively compressed using entropy coding, which may result in smaller storage requirements, faster and more efficient transmission of the point cloud data, and faster and more efficient processing of the point cloud data.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example point cloud coding system.

FIG. 2 shows a Morton order of eight sub-cuboids split from a cuboid.

FIG. 3 shows an example of a scanning order for an occupancy tree.

FIG. 4 shows an example neighborhood of cuboids for entropy coding the occupancy of a child cuboid.

FIG. 5 shows an example of a dynamic reduction function (DR) that may be used in dynamic OBUF.

FIG. 6 shows an example method for coding occupancy of a cuboid using dynamic OBUF.

FIG. 7 shows an example of an occupied cuboid that corresponds to a TriSoup node of an occupancy tree.

FIG. 8A shows an example cuboid corresponding to a TriSoup node.

FIG. 8B shows an example refinement to a TriSoup model.

FIG. 9 shows an example of voxelization.

FIG. 10A and FIG. 10B show cuboids with volumes that intersect a current TriSoup edge being entropy coded.

FIG. 11A, FIG. 11B, and FIG. 11C show TriSoup edges that may be used to entropy code a current TriSoup edge.

FIG. 12A, FIG. 12B, and FIG. 12C show already-coded TriSoup edges that neighbor and do not intersect a start point of a current TriSoup edge.

FIG. 13A, FIG. 13B, and FIG. 13C show already-coded TriSoup edges that neighbor and do not intersect a start point of a current TriSoup edge.

FIG. 14A, FIG. 14B, and FIG. 14C show neighboring already coded edges of a current TriSoup edge.

FIG. 15A, FIG. 15B, and FIG. 15C show an example of a sub-spatial topology of TriSoup edges.

FIG. 16A, FIG. 16B, and FIG. 16C show neighboring already coded edges.

FIG. 17A, FIG. 17B, and FIG. 17C show an example of a sub-spatial topology of TriSoup edges.

FIG. 18A, FIG. 18B, and FIG. 18C show a spatial topology comprising TriSoup edges and TriSoup nodes.

FIG. 19A, FIG. 19B, and FIG. 19C show examples of vertex information of a TriSoup edge E′ used for entropy coding vertex information.

FIG. 20A, FIG. 20B, FIG. 20C and FIG. 20D show examples of aggregating vertex information of a plurality of TriSoup edges.

FIG. 21 shows an example of aggregating vertex information of the plurality of TriSoup edges illustrated in FIG. 20A and occupancy states of a plurality of TriSoup nodes.

FIG. 22A and FIG. 22B show example methods for coding vertex information of a current edge.

FIG. 23 shows a block diagram of an exemplary computer system in which embodiments of the present disclosure may be implemented.

FIG. 24 shows example elements of a computing device that may be used to implement any of the various devices described herein.

### DETAILED DESCRIPTION

The accompanying drawings and descriptions provide examples. It is to be understood that the examples shown in the drawings and/or described are non-exclusive, and that features shown and described may be practiced in other examples. Examples are provided for operation of point cloud or point cloud sequence encoding or decoding systems. More particularly, the technology disclosed herein may relate to point cloud compression as used in encoding and/or decoding devices and/or systems.

Visual data may describe an object or scene using a series of points. Each point may comprise a position in two dimensions (x and y) and one or more optional attributes like color. Volumetric visual data may add another positional dimension to this visual data. Volumetric visual data may describe an object or scene using a series of points that each comprise a position in three dimensions (x, y, and z) and one or more optional attributes like color, reflectance, time stamp, etc. Volumetric visual data may provide a more immersive way to experience visual data, for example, than traditional visual data.

For example, an object or scene described by volumetric visual data may be viewed from any (or multiple) angles, whereas traditional visual data may generally only be viewed from the angle in which it was captured or rendered. Volumetric visual data may be used in many applications, including augmented reality (AR), virtual reality (VR), and mixed reality (MR). Sparse volumetric visual data may be used in the automotive industry for the representation of three-dimensional (3D) maps (e.g., cartography) or as input to assisted driving systems. In the case of assisted driving systems, volumetric visual data may be typically input to driving decision algorithms. Volumetric visual data may be used to store valuable objects in digital form. In applications for preserving cultural heritage, the goal may be to keep a representation of objects that may be threatened by natural disasters. For example, statues, vases, and temples may be entirely scanned and stored as volumetric visual data having several billions of samples. This use-case for volumetric visual data may be particularly relevant for valuable objects in locations where earthquakes, tsunamis, and typhoons are frequent. Volumetric visual data may take the form of a volumetric frame. The volumetric frame may describe an object or scene captured at a particular time instance. Volumetric visual data may take the form of a sequence of volumetric frames (referred to as a volumetric sequence or volumetric video). The sequence of volumetric frames may describe an object or scene captured at multiple different time instances.

Point clouds are one format for storing volumetric visual data. A point cloud may comprise a collection of points in 3D space. Each point in a point cloud may comprise geometry information that indicates the point's position in 3D space. The geometry information may indicate the point's position in 3D space, for example, using three Cartesian coordinates (x, y, and z) or using spherical coordinates (r, phi, theta) (e.g., if acquired by a rotating sensor). The positions of points in a point cloud may be quantized according to a space precision. The space precision may be the same or different in each dimension. The quantization process may create a grid in 3D space. One or more points residing within each sub-grid volume may be mapped to the sub-grid center coordinates, referred to as voxels. A voxel may be considered as a 3D extension of pixels corresponding to the 2D image grid coordinates. A point in a point cloud may further comprise one or more types of attribute information. Attribute information may indicate a property of a point's visual appearance. Attribute information may indicate, for example, a texture (e.g., color) of the point, a material type of the point, transparency information of the point, reflectance information of the point, a normal vector to a surface of the point, a velocity at the point, an acceleration at the point, a time stamp indicating when the point was captured, or a modality indicating how the point was captured (e.g., running, walking, or flying). A point in a point cloud may comprise light field data in the form of multiple view-dependent texture information. Light field data may be another type of optional attribute information.

The points in a point cloud may describe an object or a scene. The points in a point cloud may describe, for example, the external surface and/or the internal structure of an object or scene. The object or scene may be synthetically generated by a computer. The object or scene may be generated from the capture of a real-world object or scene. The geometry information of a real-world object or a scene may be obtained by 3D scanning and/or photogrammetry. 3D scanning may include different types of scanning, for example, laser scanning, structured light scanning, and/or modulated light scanning. 3D scanning may obtain geometry information. 3D scanning may obtain geometry information, for example, by moving one or more laser heads, structured light cameras, and/or modulated light cameras relative to an object or scene being scanned. Photogrammetry may obtain geometry information. Photogrammetry may obtain geometry information, for example, by triangulating the same feature or point in different spatially shifted 2D photographs. Point cloud data may take the form of a point cloud frame. The point cloud frame may describes an object or scene captured at a particular time instance. Point cloud data may take the form of a sequence of point cloud frames. The sequence of point cloud frames may be referred to as a point cloud sequence or point cloud video. The sequence of point cloud frames may describe an object or scene captured at multiple different time instances.

The data size of a point cloud frame or point cloud sequence may be too large for storage and/or transmission in many applications. A single point cloud may comprise, for example, over a million points or even a billions of points. Each point may comprise geometry information and one or more optional types of attribute information. The geometry information of each point may comprise three Cartesian coordinates (x, y, and z) or spherical coordinates (r, phi, theta) that are each represented, for example, using at least 10 bits per component or 30 bits in total. The attribute information of each point may comprise a texture corresponding to three color components (e.g., R, G, and B color components). Each color component may be represented, for example, using 8-10 bits per component or 24-30 bits in total. A single point therefore may comprise at least 54 bits of information in this example, with at least 30 bits of geometry information and at least 24 bits of texture. If a point cloud frame includes a million such points, each point cloud frame may require 54 million bits or 54 megabits to represent. For dynamic point clouds that change over time, at a frame rate of 30 frames per second, a data rate of 1.32 gigabits per second may be required to send (e.g., transmit) the points of the point cloud sequence. Therefore, raw representations of point clouds may require a large amount of data and the practical deployment of point-cloud-based technologies may need compression technologies that enable the storage and distribution of point clouds with reasonable cost.

Encoding may be used to compress and/or reduce the data size of a point cloud frame or point cloud sequence to provide for more efficient storage and/or transmission. Decoding may be used to decompress a compressed point cloud frame or point cloud sequence for display and/or other forms of consumption (e.g., by a machine learning based device, neural network-based device, artificial intelligence-based device, or other forms of consumption by other types of machine-based processing algorithms and/or devices). Compression of point clouds may be lossy (introducing differences relative to the original data) for the distribution to and visualization by an end-user, for example, on AR or VR glasses or any other 3D-capable device. Lossy compression may allow for a high ratio of compression but may imply a trade-off between compression and visual quality perceived by an end-user. Other frameworks, for example, frameworks for medical applications or autonomous driving, may require lossless compression to avoid altering the results of a decision obtained based on the analysis of the sent (e.g., transmitted) and decompressed point cloud frame.

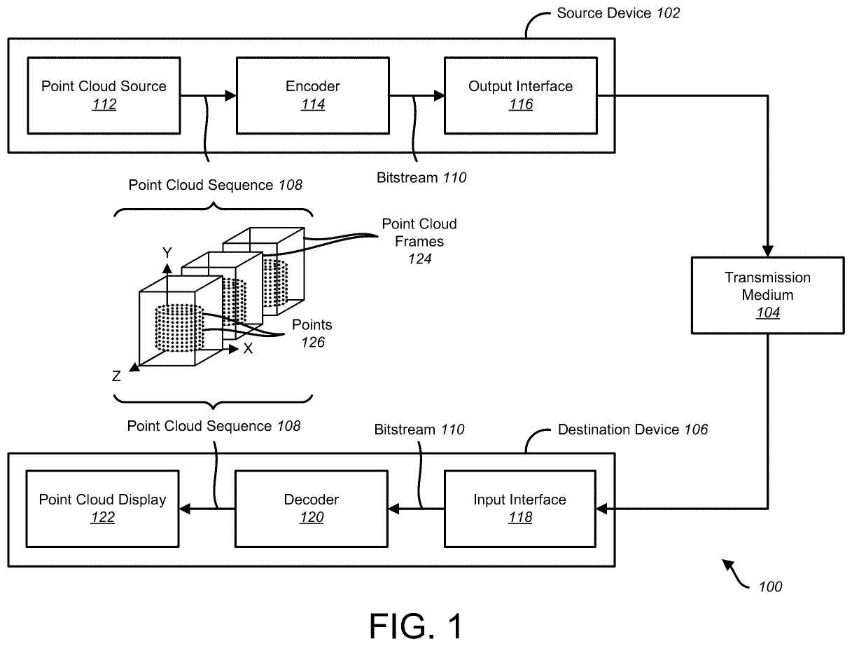

FIG. 1 shows an example point cloud coding (e.g., encoding and/or decoding) system 100. Point cloud coding system 100 may comprise a source device 102, a transmission medium 104, and a destination device 106. Source device 102 may encode a point cloud sequence 108 into a bitstream 110 for more efficient storage and/or transmission. Source device 102 may store and/or send (e.g., transmit) bitstream 110 to destination device 106 via transmission medium 104. Destination device 106 may decode bitstream 110 to display point cloud sequence 108 or for other forms of consumption (e.g., further analysis, storage, etc.). Destination device 106 may receive bitstream 110 from source device 102 via a storage medium or transmission medium 104. Source device 102 and destination device 106 may include any number of different devices. Source device 102 and destination device 106 may include, for example, cluster of interconnected computer systems acting as a pool of seamless resources (also referred to as a cloud of computers or cloud computer), a server, a desktop computer, a laptop computer, a tablet computer, a smart phone, a wearable device, a television, a camera, a video gaming console, a set-top box, a video streaming device, a vehicle (e.g., an autonomous vehicle), or a head-mounted display. A head-mounted display may allow a user to view a VR, AR, or MR scene and adjust the view of the scene based on movement of the user's head. A head-mounted display may be tethered to a processing device (e.g., a server, a desktop computer, a set-top box, or a video gaming counsel) or may be fully self-contained.

Source device 102 may comprise a point cloud source 112, an encoder 114, and an output interface 116. To encode point cloud sequence 108 into bitstream 110, source device 102 may comprise a point cloud source 112, an encoder 114, and an output interface 116. Point cloud source 112 may provide or generate point cloud sequence 108 from a capture of a natural scene and/or a synthetically generated scene. A synthetically generated scene may be a scene comprising computer generated graphics. Point cloud source 112 may comprise one or more point cloud capture devices, a point cloud archive comprising previously captured natural scenes and/or synthetically generated scenes, a point cloud feed interface to receive captured natural scenes and/or synthetically generated scenes from a point cloud content provider, and/or a processor(s) to generate synthetic point cloud scenes. The point cloud capture devices may include, for example, one or more laser scanning devices, structured light scanning devices, modulated light scanning devices, and/or passive scanning devices.

As shown in FIG. 1, a point cloud sequence 108 may comprise a series of point cloud frames 124. A point cloud frame may describe an object or scene captured at a particular time instance. Point cloud sequence 108 may achieve the impression of motion by using a constant or variable time to successively present point cloud frames 124 of point cloud sequence 108. A point cloud frame may comprise a collection of points (e.g., voxels) 126 in 3D space. Each point 126 may comprise geometry information that indicates the point's position in 3D space. The geometry information may indicate, for example, the point's position in 3D space using three Cartesian coordinates (x, y, and z). One or more of points 126 may further comprise one or more types of attribute information. Attribute information may indicate a property of a point's visual appearance. Attribute information may indicate, for example, a texture (e.g., color) of a point, a material type of a point, transparency information of a point, reflectance information of a point, a normal vector to a surface of a point, a velocity at a point, an acceleration at a point, a time stamp indicating when a point was captured, a modality indicating how a point was captured (e.g., running, walking, or flying). One or more of points 126 may comprise, for example, light field data in the form of multiple view-dependent texture information. Light field data may be another type of optional attribute information. Color attribute information of one or more of points 126 may comprise a luminance value and two chrominance values. The luminance value may represent the brightness (e.g., luma component, Y) of the point. The chrominance values may respectively represent the blue and red components of the point (e.g., chroma components, Cb and Cr) separate from the brightness. Other color attribute values may be represented based on different color schemes (e.g., an RGB or monochrome color scheme).

Encoder 114 may encode point cloud sequence 108 into bitstream 110. To encode point cloud sequence 108, encoder 114 may use one or more lossless or lossy compression techniques to reduce redundant information in point cloud sequence 108. To encode point cloud sequence 108, encoder 114 may use one or more prediction techniques to reduce redundant information in point cloud sequence 108. Redundant information is information that may be predicted at a decoder 120 and therefore may not be needed to be sent (e.g., transmitted) to decoder 120 for accurate decoding of point cloud sequence 108. For example, Motion Picture Expert Group (MPEG) introduced a geometry-based point cloud compression (G-PCC) standard (ISO/IEC standard 23090-9: Geometry-based point cloud compression). G-PCC specifies the encoded bitstream syntax and semantics for transmission and/or storage of a compressed point cloud frame and the decoder operation for reconstructing the compressed point cloud frame from the bitstream. During standardization of G-PCC, a reference software (ISO/IEC standard 23090-21: Reference Software for G-PCC) was developed to encode the geometry and attribute information of a point cloud frame. To encode geometry information of a point cloud frame, the G-PCC reference software encoder may perform voxelization. The G-PCC reference software encoder may perform voxelization, for example, by quantizing positions of points in a point cloud. Quantizing positions of points in a point cloud may create a grid in 3D space. The G-PCC reference software encoder may map the points to the center coordinates of the sub-grid volume (e.g., voxel) that their quantized locations reside in. The G-PCC reference software encoder may perform geometry analysis using an occupancy tree to compress the geometry information. The G-PCC reference software encoder may entropy encode the result of the geometry analysis to further compress the geometry information. To encode attribute information of a point cloud, the G-PCC reference software encoder may use a transform tool, such as Region Adaptive Hierarchical Transform (RAHT), the Predicting Transform, and/or the Lifting Transform. The Lifting Transform may be built on top of the Predicting Transform. The Lifting Transform may include an extra update/lifting step. The Lifting Transform and the Predicting Transform may be referred to as Predicting/Lifting Transform or pred lift. Encoder 114 may operate in a same or similar manner to an encoder provided by the G-PCC reference software.

Output interface 116 may be configured to write and/or store bitstream 110 onto transmission medium 104. The bitstream 110 may be sent (e.g., transmitted) to destination device 106. In addition or alternatively, output interface 116 may be configured to send (e.g., transmit), upload, and/or stream bitstream 110 to destination device 106 via transmission medium 104. Output interface 116 may comprise a wired and/or wireless transmitter configured to send (e.g., transmit), upload, and/or stream bitstream 110 according to one or more proprietary and/or standardized communication protocols. The one or more proprietary and/or standardized communication protocols may include, for example, Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Transmission medium 104 may comprise a wireless, wired, and/or computer readable medium. Transmission medium 104 may comprise, for example, one or more wires, cables, air interfaces, optical discs, flash memory, and/or magnetic memory. In addition, or alternatively, transmission medium 104 may comprise one or more networks (e.g., the Internet) or file server(s) configured to store and/or send (e.g., transmit) encoded video data (e.g., bitstream 110).

Destination device 106 may comprise an input interface 118, a decoder 120, and a point cloud display 122. To decode bitstream 110 into point cloud sequence 108 for display or other forms of consumption, destination device 106 may comprise an input interface 118, a decoder 120, and a point cloud display 122. Input interface 118 may be configured to read bitstream 110 stored on transmission medium 104. Bitstream 110 may be stored on transmission medium 104 by source device 102. In addition or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary and/or standardized communication protocols, such as Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Decoder 120 may decode point cloud sequence 108 from encoded bitstream 110. Decoder 120 may operate, for example, in a same or similar manner as a decoder provided by G-PCC reference software. Decoder 120 may decode a point cloud sequence that approximates point cloud sequence 108. Decoder 120 may decode a point cloud sequence that approximates point cloud sequence 108 due to, for example, lossy compression of point cloud sequence 108 by encoder 114 and/or errors introduced into encoded bitstream 110, for example, if transmission to destination device 106 occurs.

Point cloud display 122 may display point cloud sequence 108 to a user. Point cloud display 122 may comprise, for example, a cathode rate tube (CRT) display, a liquid crystal display (LCD), a plasma display, a light emitting diode (LED) display, a 3D display, a holographic display, a head-mounted display, or any other display device suitable for displaying point cloud sequence 108.

Point cloud coding/decoding system 100 is presented by way of example and not limitation. In the example of FIG. 1, point cloud coding/decoding system 100 may have other components and/or arrangements. Point cloud source 112 may, for example, be external to source device 102. Point cloud display device 122 may, for example, be external to destination device 106 or omitted altogether where point cloud sequence is intended for consumption by a machine and/or storage device. Source device 102 may further comprise, for example, a point cloud decoder. Destination device 104 may comprise, for example, a point cloud encoder. Source device 102 may be configured to further receive an encoded bit stream from destination device 106. Receiving an encoded bit stream from destination device 106 may support two-way point cloud transmission between the devices.

As described herein, an encoder may quantize the positions of points in a point cloud according to a space precision, which may be the same or different in each dimension of the points. The quantization process may create a grid in 3D space. The encoder may map any points residing within each sub-grid volume to the sub-grid center coordinates, referred to as a voxel. A voxel may be considered as a 3D extension of pixels corresponding to 2D image grid coordinates.

The encoder may represent or code the voxelized point cloud. The encoder may represent or code the voxelized point cloud, for example, using an occupancy tree. The encoder may split the initial volume or cuboid containing the voxelized point cloud into sub-cuboids. The initial volume or cuboid may be referred to as a bounding box. A cuboid may be, for example, a cube. The encoder may recursively split each sub-cuboid that contains at least one point of the point cloud. The encoder may not further split sub-cuboids that do not contain at least one point of the point cloud. A sub-cuboid that contains at least one point of the point cloud may be referred to as an occupied sub-cuboid. A sub-cuboid that does not contain at least one point of the point cloud may be referred to as an unoccupied sub-cuboid. The encoder may split an occupied cuboid into, for example, two sub-cuboids (to form a binary tree), four sub-cuboids (to form a quadtree), or eight sub-cuboids (to form an octrec). The encoder may split an occupied cuboid to obtain sub-cuboids. The sub-cuboids may have the same size and shape at a given depth level of the occupancy tree. The sub-cuboids may have the same size and shape at a given depth level of the occupancy tree, for example, if the encoder splits the occupied cuboid along a plane passing through the middle of edges of the cuboid.

The initial volume or cuboid containing the voxelized point cloud may correspond to the root node of the occupancy tree. Each occupied sub-cuboid, split from the initial volume, may correspond to a node (of the root node) in a second level of the occupancy tree. Each occupied sub-cuboid, split from an occupied sub-cuboid in the second level, may correspond to a node (off the occupied sub-cuboid in the second level from which it was split) in a third level of the occupancy tree. The occupancy tree structure may continue to form in this manner for each recursive split iteration until, for example, some maximum depth level of the occupancy tree is reached or each occupied sub-cuboid has a volume corresponding to one voxel.

Each non-leaf node of the occupancy tree may comprise or be associated with an occupancy word representing the occupancy state of the cuboid corresponding to the node. A node of the occupancy tree corresponding to a cuboid that is split into 8 sub-cuboids may comprise or be associated with a 1-byte occupancy word. Each bit (referred to as an occupancy bit) of the 1-byte occupancy word may represent or indicate the occupancy of a different one of the eight sub-cuboids. Occupied sub-cuboids may be each represented or indicated by a binary “1” in the 1-byte occupancy word. Unoccupied sub-cuboids may be each represented or indicated by a binary “0” in the 1-byte occupancy word. Occupied and un-occupied sub-cuboids may be represented or indicated by opposite 1-bit binary values (e.g., a binary “0” representing or indicating an occupied sub-cuboid and a binary “1” representing or indicating an unoccupied sub-cuboid) in the 1-byte occupancy word.

Each bit of an occupancy word may represent or indicate the occupancy of a different one of the eight sub-cuboids. Each bit of an occupancy word may represent or indicate the occupancy of a different one of the eight sub-cuboids, for example, following the so-called Morton order. The least significant bit of an occupancy word may represent or indicate, for example, the occupancy of a first one of the eight sub-cuboids following the Morton order. The second least significant bit of an occupancy word may represent or indicate, for example, the occupancy of a second one of the eight sub-cuboids following the Morton order, etc.

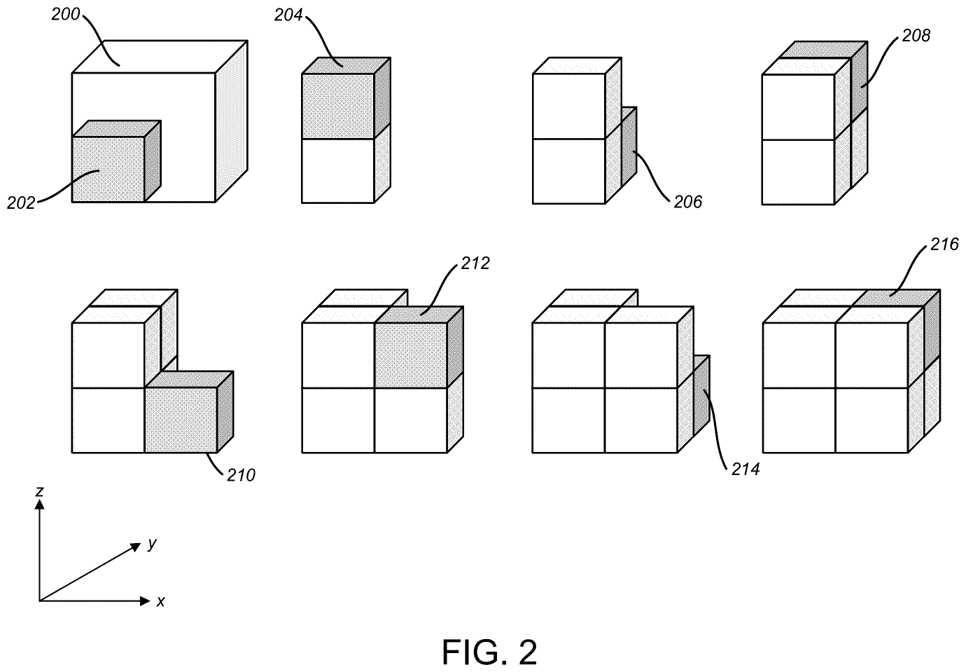

FIG. 2 shows the Morton order of eight sub-cuboids 202-216 split from a cuboid 200. Sub-cuboids 202-216 are labeled based on their Morton order, with child node 202 being the first in Morton order and child node 216 being the last in Morton order. The Morton order for sub-cuboids 202-216 is a local lexicographic order in xyz.

The geometry of the voxelized point cloud is represented by, and may be determined from, the initial volume and the occupancy words of the nodes in the occupancy tree. The encoder may send (e.g., transmit) the initial volume and the occupancy words of the nodes in the occupancy tree in a bitstream to a decoder for reconstructing the point cloud. The encoder may entropy encode the occupancy words. The encoder may entropy encode the occupancy words, for example, before sending the initial volume and the occupancy words of the nodes in the occupancy tree. The encoder may encode an occupancy bit of an occupancy word of a node corresponding to a cuboid. The encoder may encode an occupancy bit of an occupancy word of a node corresponding to a cuboid, for example, based on one or more occupancy bits of occupancy words of other nodes corresponding to cuboids that are adjacent or spatially close to the cuboid of the occupancy bit being encoded.

An encoder and/or decoder may code occupancy bits of occupancy words in sequence of a scan order. The scan order may also be referred to as a scanning order. An encoder and/or decoder may scan an occupancy tree in breadth-first order. All the occupancy words of the nodes of a given depth (e.g., level) within the occupancy tree may be scanned. All the occupancy words of the nodes of a given depth (e.g., level) within the occupancy tree may be scanned, for example, before scanning the occupancy words of the nodes of the next depth (e.g., level). Within a given depth, the encoder and/or decoder may scan the occupancy words of nodes in the Morton order. Within a given node, the encoder and/or decoder may scan the occupancy bits of the occupancy word of the node further in the Morton order.

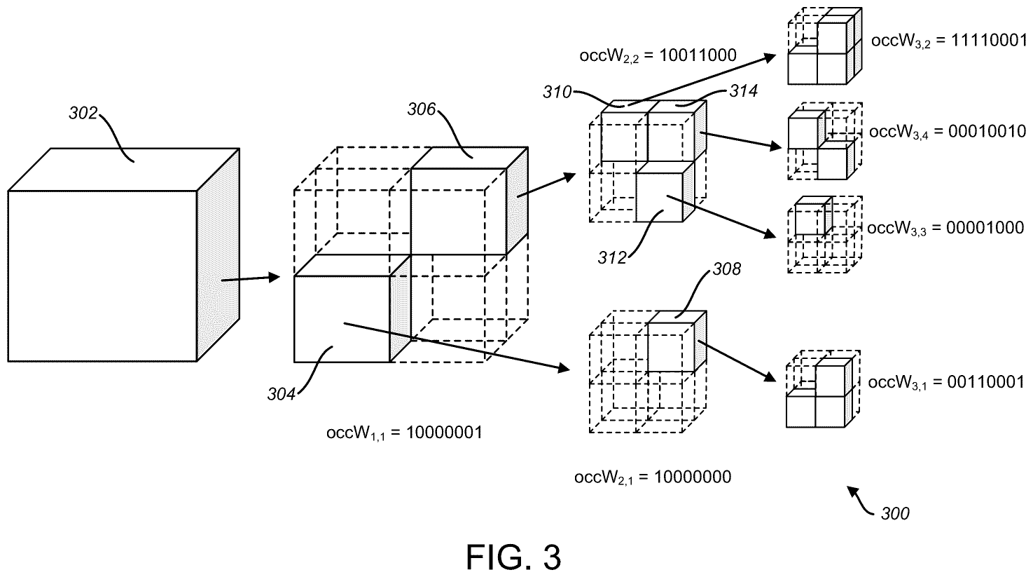

FIG. 3 shows an example of a scanning order (e.g., breadth-first order as described herein) for an occupancy tree 300. FIG. 3 shows a scanning order for the first three example levels of occupancy tree 300. In FIG. 3, a cuboid 302 corresponding to the root node of occupancy tree 300 may be divided into eight sub-cuboids. Two sub-cuboids 304 and 306 of the eight sub-cuboids may be occupied. The other six sub-cuboids of the eight sub-cuboids may be unoccupied. Following the Morton order, a first eight-bit occupancy word occW_{1,1} is constructed to represent the occupancy word of the root node. The least significant occupancy bit of the first eight-bit occupancy word occW_{1,1} represents or indicates the occupancy of the first sub-cuboid of the eight sub-cuboids in Morton order. The second least significant occupancy bit of the first eight-bit occupancy word occW_{1,1} represents or indicates the occupancy of the second sub-cuboid of the eight sub-cuboids in Morton order, etc.

Each of the two occupied sub-cuboids 304 and 306 corresponds to a node off the root node in a second level of occupancy tree 300. The two occupied sub-cuboids 304 and 306 are each further split into eight sub-cuboids. One of the sub-cuboids 308 of the eight sub-cuboids split from sub-cuboid 304 may be occupied. The other seven sub-cuboids of the eight sub-cuboids split from sub-cuboid 304 may be unoccupied. Three of the sub-cuboids 310, 312, and 314 of the eight sub-cuboids split from sub-cuboid 306 may be occupied. The other five sub-cuboids of the eight sub-cuboids split from sub-cuboid 306 may be unoccupied. Two second eight-bit occupancy words occW_{2,1} and occW_{2,2} are constructed in this order to respectively represent the occupancy word of the node corresponding to sub-cuboid 304 and the occupancy word of the node corresponding to sub-cuboid 306.

Each of the four occupied sub-cuboids 308, 310, 312, and 314 corresponds to a node in a third level of occupancy tree 300. The four occupied sub-cuboids 308, 310, 312, and 314 are each further split into eight sub-cuboids or 32 sub-cuboids in total. Four third level eight-bit occupancy words occW_{3,1}, occW_{3,2}, occW_{3,3} and occW_{3,4} are constructed in this order to respectively represent the occupancy word of the node corresponding to sub-cuboid 308, the occupancy word of the node corresponding to sub-cuboid 310, the occupancy word of the node corresponding to sub-cuboid 312, and the occupancy word of the node corresponding to sub-cuboid 314.

The occupancy words of occupancy tree 300 may be entropy coded (e.g., entropy encoded by an encoder and entropy decoded by a decoder) as the succession of the seven occupancy words occW_{1,1} to occW_{3,4}, for example, following the scanning order (e.g., breadth-first order) as described herein. As a consequence of the breadth-first scanning order, the occupancy word(s) of all node(s) having the same depth (e.g., level) as a current parent node may have already been entropy coded, for example, if the occupancy word of a current child node belonging to the current parent node is being entropy coded. The occupancy word(s) of all node(s) having the same depth (e.g., level) as the current child node and having a lower Morton order than the current child node may have also already been entropy coded, for example, if the occupancy word for the current child node is being entropy coded. Part of the already coded occupancy word(s) may be used to entropy code the occupancy word of the current child node. The already coded occupancy word(s) of neighboring parent and/or child node(s) may be used, for example, to entropy code the occupancy word of the current child node. The occupancy bit(s) of the occupancy word having a lower Morton order than a particular occupancy bit of the occupancy word of the current child node may have also already been entropy coded. The occupancy bit(s) of the occupancy word having a lower Morton order than a particular occupancy bit may be used to code the occupancy bit of the occupancy word of the current child node, for example, if the particular occupancy bit is being coded.

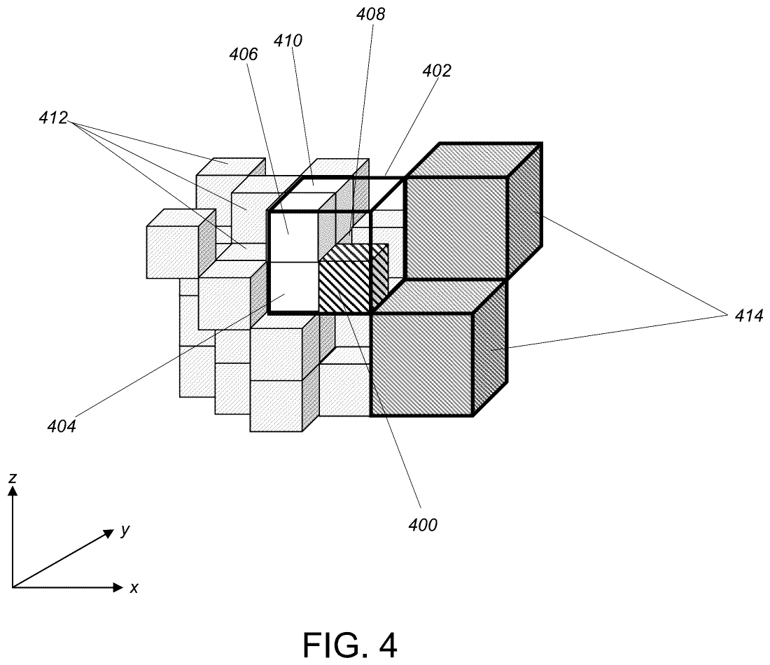

FIG. 4 shows an example neighborhood of cuboids for entropy coding the occupancy of a child cuboid. A neighborhood of cuboids with already-coded occupancy bits may be used to entropy code the occupancy bit of a current child cuboid 400. The neighborhood of cuboids with already-coded occupancy bits may be determined. The neighborhood of cuboids with already-coded occupancy bits may be determined, for example, based on the scanning order of an occupancy tree representing the geometry of the cuboids in FIG. 4 as described herein. The neighborhood of cuboids, of a current child cuboid, may include one or more of: a cuboid adjacent to the current child cuboid, a cuboid sharing a vertex with the current child cuboid, a cuboid sharing an edge with the current child cuboid, a cuboid sharing a face with the current child cuboid, a parent cuboid adjacent to the current child cuboid, a parent cuboid sharing a vertex with the current child cuboid, a parent cuboid sharing an edge with the current child cuboid, a parent cuboid sharing a face with the current child cuboid, a parent cuboid adjacent to the current parent cuboid, a parent cuboid sharing a vertex with the current parent cuboid, a parent cuboid sharing an edge with the current parent cuboid, a parent cuboid sharing a face with the current parent cuboid, etc. As shown in FIG. 4, current child cuboid 400 may belong to a current parent cuboid 402. Following the scanning order of the occupancy words and occupancy bits of nodes of the occupancy tree, the occupancy bits of four child cuboids 404, 406, 408, and 410, belonging to the same current parent cuboid 402, have already been coded. The occupancy bits of child cuboids 412 of preceding parent cuboids have already been coded. The occupancy bits of parent cuboids 414, for which the occupancy bits of child cuboids have not already been coded, have already been coded. Therefore, the already-coded occupancy bits of cuboids 404, 406, 408, 410, 412, and 414 may be used to code the occupancy bit of the current child cuboid 400.

The number (e.g., quantity) of possible occupancy configurations (e.g., sets of one or more occupancy words and/or occupancy bits) for a neighborhood of a current child cuboid may be 2^{N}, where N is the number (e.g., quantity) of cuboids in the neighborhood of the current child cuboid with already-coded occupancy bits. The neighborhood of the current child cuboid may comprise several dozens of cuboids. The neighborhood of the current child cuboid may comprise the 26 adjacent parent cuboids sharing a face, an, edge, and/or a vertex with the parent cuboid of the current child cuboid and also several adjacent child cuboids sharing a face, an edge, and/or a vertex with the current child cuboid. The occupancy configuration for a neighborhood of the current child cuboid may have billions of possible occupancy configurations, even limited to a subset of the adjacent cuboids, making its direct use impractical. An encoder and/or decoder may use the occupancy configuration for a neighborhood of the current child cuboid to select the context (e.g., a probability model), among a set of contexts, of a binary entropy coder (e.g., binary arithmetic coder) that codes the occupancy bit of the current child cuboid. The context-based binary entropy coding may be similar to the Context Adaptive Binary Arithmetic Coder (CABAC) used in MPEG-H Part 2 (also known as High Efficiency Video Coding (HEVC)).

An encoder and/or decoder may use several methods to reduce the occupancy configurations for a neighborhood of a current child cuboid being coded to a practical number (e.g., quantity) of reduced occupancy configurations. The 2⁶ or 64 occupancy configurations of the six adjacent parent cuboids sharing a face with the parent cuboid of the current child cuboid may be reduced to nine occupancy configurations. The occupancy configurations may be reduced by using geometry invariance. An occupancy score for the current child cuboid may be obtained from the 2²⁶ occupancy configurations of the 26 adjacent parent cuboids. The score may be further reduced into a ternary occupancy prediction (e.g., “predicted occupied,” “unsure,” or “predicted unoccupied”) by using score thresholds. The number (e.g., quantity) of occupied adjacent child cuboids and the number (e.g., quantity) of unoccupied adjacent child cuboids may be used instead of the individual occupancies of these child cuboids.

An encoder and/or decoder may reduce the number (e.g., quantity) of possible occupancy configurations for a neighborhood of a current child cuboid to a more manageable number (e.g., a few thousands). It has been observed that instead of associating a reduced number (e.g., quantity) of contexts (e.g., probability models) directly to the reduced occupancy configurations, another mechanism may be used, namely Optimal Binary Coders with Update on the Fly (OBUF). An encoder and/or decoder may implement OBUF to limit the number (e.g., quantity) of contexts to a lower number (e.g., 32 contexts).

OBUF may use a limited number (e.g., 32) of contexts (e.g., probability models). The number (e.g., quantity) of contexts in OBUF may be a fixed number (e.g., fixed quantity). The contexts used by OBUF may be ordered, referred to by a context index (e.g., a context index in the range of 0 to 31), and associated from a lowest virtual probability to a highest virtual probability to code a “1.” A Look-Up Table (LUT) of context indices may be initialized at the beginning of a point cloud coding process. The LUT may initially point to a context with the median virtual probability to code a “1” for all input. The LUT may initially point to a context with the median virtual probability to code a “1,” among the limited number (e.g., quantity) of contexts, for all input. This LUT may take an occupancy configuration for a neighborhood of current child cuboid as input and output the context index associated with the occupancy configuration. The LUT may have as many entries as reduced occupancy configurations (e.g., around a few thousand entries). The coding of the occupancy bit of a current child cuboid may comprise the steps of determining the reduced occupancy configuration of the current child node, obtaining a context index by using the reduced occupancy configuration as an entry to the LUT, coding the occupancy bit of the current child cuboid by using the context pointed to (e.g., indicated) by the context index, and updating the LUT entry corresponding to the reduced occupancy configuration. The LUT entry may be updated, for example, based on the value of the coded occupancy bit of the current child cuboid. For a binary “0” (e.g., indicating the current child cuboid is unoccupied) being coded, the LUT entry may be decreased to a lower context index value (e.g., associated with a lower virtual probability). For a binary “1” (e.g., indicating the current child cuboid is occupied) being coded, the LUT entry may be increased to a higher context index value (e.g., associated with a higher virtual probability). The update process of the context index may be based on a theoretical model of optimal distribution for virtual probabilities associated with the limited number (e.g., quantity) of contexts. This virtual probability may be fixed by a model. This virtual probability may be different from the internal probability of the context that evolves during the coding of bits of data. The evolution of the internal context may follow a well-known process similar to the process in CABAC.

An encoder and/or decoder may implement a “dynamic OBUF” scheme. The “dynamic OBUF” scheme may handle a much larger number (e.g., quantity) of occupancy configurations for a neighborhood of a current child cuboid than general OBUF. The use of a larger number (e.g., quantity) of occupancy configurations for a neighborhood of a current child cuboid may lead to improved compression capabilities. The use of a larger number (e.g., quantity) of occupancy configurations for a neighborhood of a current child cuboid may also maintain complexity within reasonable bounds. By using an occupancy tree compressed by OBUF, an encoder and/or decoder may reach a lossless compression performance as good as 1 bit per point (bpp) for coding the geometry of dense point clouds. An encoder and/or decoder may implement dynamic OBUF to potentially further reduce the bit rate by more than 25% to 0.7 bpp.

OBUF may not take as input a large variety of reduced occupancy configurations for a neighborhood of a current child cuboid. This may potentially lead to a loss of useful correlation. With OBUF, the size of the LUT of context indices may be increased to handle more various occupancy configurations for a neighborhood of a current child cuboid as input. By doing so, statistics may be diluted, and compression performance may be worsened. For example, if the LUT has millions of entries and the point cloud has a hundred thousand points, then most of the entries are never visited (e.g., looked up, accessed, etc.). In some instances, many entries may be visited only a few times and their associated context index may not be updated enough times to reflect any meaningful correlation between the occupancy configuration value and the probability of occupancy of the current child cuboid. Dynamic OBUF may be implemented to mitigate the dilution of statistics due to the increase of the number (e.g., quantity) of occupancy configurations for a neighborhood of a current child cuboid. This mitigation is performed by a “dynamic reduction” of occupancy configurations in dynamic OBUF.

Dynamic OBUF may add an extra step of reduction of occupancy configurations for a neighborhood of a current child cuboid. Dynamic OBUF may add an extra step of reduction of occupancy configurations for a neighborhood of a current child cuboid, for example, before using the LUT of context indices. This step may be called a dynamic reduction because it evolves based on the progress of the coding of the point cloud or, more precisely, based on already visited (e.g., looked up in the LUT) occupancy configurations.

As described herein, many possible occupancy configurations for a neighborhood of a current child cuboid are potentially involved but only a subset may be visited, for example, if the coding of a point cloud occurs. This subset of visited occupancy configurations may characterize the type of the point cloud. For example, most of the visited occupancy configurations may exhibit occupied adjacent cuboids of a current child cuboid, for example, if AR or VR dense point clouds are being coded. On the other hand, most of the visited occupancy configurations may exhibit only a few occupied adjacent cuboids of a current child cuboid, for example, if sensor-acquired sparse point clouds are being coded. The role of the dynamic reduction may be to obtain a more precise correlation based on the most visited occupancy configuration, for example, by putting aside (e.g., reducing aggressively) other occupancy configurations that are much less visited. The dynamic reduction may be updated on-the-fly. The dynamic reduction may be updated on-the-fly. The dynamic reduction may be updated on-the-fly, for example, after each visit (e.g., a lookup in the LUT) of an occupancy configuration. A visit (e.g., a lookup in the LUT) of an occupancy configuration may occur, for example, if the coding of occupancy data occurs.

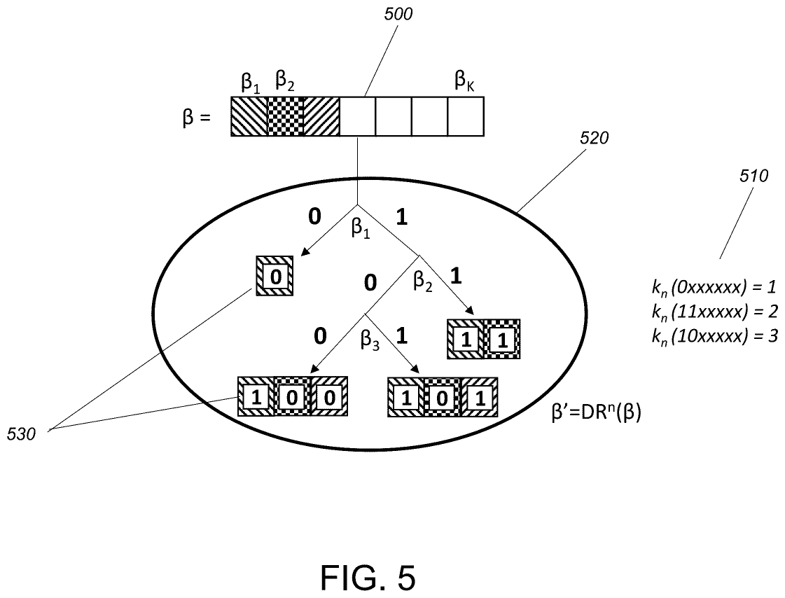

FIG. 5 shows an example of a dynamic reduction function (DR) that may be used in dynamic OBUF. The dynamic reduction function (DR) may be obtained by masking bits βⱼ of occupancy configurations 500,

β=β₁ . . . β_{K},

made of K bits. The size of the mask may decrease, for example, if occupancy configurations are visited (e.g., looked up in the LUT) a certain number (e.g., quantity) of times. The initial dynamic reduction function DR⁰ may mask all bits for all occupancy configurations such that it is a constant function DR⁰(β)=0 for all occupancy configurations β. The dynamic reduction function may evolve from a function DRⁿ to an updated function DRⁿ⁺¹. The dynamic reduction function may evolve from a function DRⁿ to an updated function DRⁿ⁺¹, for example, after each coding of an occupancy bit. The function may be defined by

β′=DRⁿ(β)=β₁ . . . β_{kn(β)},

where kₙ(β) 510 is the number (e.g., quantity) of non-masked bits. The initialization of DR⁰ may correspond to k₀(β)=0, and the natural evolution of the reduction function toward finer statistics may lead to an increasing number (e.g., quantity) of non-masked bits kₙ(β)≤kₙ₊₁(β). The dynamic reduction function may be entirely determined by the values of kₙ for all occupancy configurations β.

The visits (e.g., instances of a lookup in the LUT) to occupancy configurations may be tracked by a variable NV(β′) for all dynamically reduced occupancy configurations β′=DRⁿ(β). The corresponding number (e.g., quantity) of visits NV(β^{V}′) may be increased by one. The corresponding number (e.g., quantity) of visits NV(β^{V}′) may be increased by one, for example, after each instance of coding of an occupancy bit based on an occupancy configuration β^{V}. If this number (e.g., quantity) of visits NV(β^{V}′) is greater than a threshold th_{V},

NV(β^{V}′)>th_{V},

then the number (e.g., quantity) of unmasked bits kₙ(β) may be increased by one for all occupancy configurations β being dynamically reduced to β^{V}′. This corresponds to replacing the dynamically reduced occupancy configuration β^{V}′ by the two new dynamically reduced occupancy configurations β⁰′ and β¹′ defined by

β⁰′=β^{V}′0=β^{V}₁ . . . β^{V}_{kn(β)}0, and β¹′=β^{V}′1=β^{V}₁ . . . β^{V}_{kn(β)}1.

In other words, the number (e.g., quantity) of unmasked bits has been increased by one kₙ₊₁(β)=kₙ(β)+1 for all occupancy configurations β such that DRⁿ(β)=β^{V}′. The number (e.g., quantity) of visits of the two new dynamically reduced occupancy configurations may be initialized to zero,

NV(β⁰′)=NV(β¹′)=0. (I)

At the start of the coding, the initial number (e.g., quantity) of visits for the initial dynamic reduction function DR⁰ may be set to

NV(DR⁰(β))=NV(0)=0,

and the evolution of NV on dynamically reduced occupancy configurations may be entirely defined.

The corresponding LUT entry LUT[β^{V}′] may be replaced by the two new entries LUT[β⁰′] and LUT[β¹′] that are initialized by the coder index associated with β^{V}′. The corresponding LUT entry LUT[β^{V}′] may be replaced by the two new entries LUT[β⁰′] and LUT[β¹′] that are initialized by the coder index associated with β^{V}′, for example, if a dynamically reduced occupancy configuration β^{V}′ is replaced by the two new dynamically reduced occupancy configurations β⁰′ and β′,

LUT[β⁰′]=LUT[β¹′]=LUT[β^{V}′], (II)

and then evolve separately. The evolution of the LUT of coder indices on dynamically reduced occupancy configurations may be entirely defined.

The reduction function DRⁿ may be modeled by a series of growing binary trees Tⁿ 520 whose leaf nodes 530 are the reduced occupancy configurations β′=DRⁿ(β). The initial tree may be the single root node associated with 0=DR⁰(β). The replacement of the dynamically reduced to β^{V}′ by β⁰′ and β¹′ corresponds to growing the tree Tⁿ from the leaf node associated with β^{V}′. The replacement of the dynamically reduced to β^{V}′ by β⁰′ and β¹′ corresponds to growing the tree Tⁿ from the leaf node associated with β^{V}′, for example, by attaching to it two new nodes associated with β⁰′ and β¹′. The tree Tⁿ⁺¹ may be obtained by this growth. The number (e.g., quantity) of visits NV and the LUT of context indices may be defined on the leaf nodes and evolve with the growth of the tree through equations (I) and (II).

The practical implementation of dynamic OBUF may be made by the storage of the array NV[β′] and the LUT[β′] of context indices, as well as the trees Tⁿ 520. An alternative to the storage of the trees may be to store the array kₙ[β] 510 of the number (e.g., quantity) of non-masked bits.

A limitation for implementing dynamic OBUF may be its memory footprint. In some instances, a few million occupancy configurations may be practically handled, leading to about 20 bits βᵢ constituting an entry configuration β to the reduction function DR. Each bit βᵢ may correspond to the occupancy status of a neighboring cuboid of a current child cuboid or a set of neighboring cuboids of a current child cuboid.

Higher (e.g., more significant) bits βᵢ (e.g., β₀, β₁, etc.) may be the first bits to be unmasked. Higher (e.g., more significant) bits βᵢ (e.g., β₀, β₁, etc.) may be the first bits to be unmasked, for example, during the evolution of the dynamic reduction function DR. The order of neighbor-based information put in the bits βᵢ may impact the compression performance. Neighboring information may be ordered from higher priority to lower priority and put, in this order, into the bits βᵢ, e.g., from higher to lower weight. The priority may be, from the most important to the least important, occupancy of sets of adjacent neighboring child cuboids, then occupancy of adjacent neighboring child cuboids, then occupancy of adjacent neighboring parent cuboids, then occupancy of non-adjacent neighboring child nodes, and finally occupancy of non-adjacent neighboring parent nodes. Adjacent nodes sharing a face with the current child node may also have higher priority than adjacent nodes sharing an edge (but not sharing a face) with the current child node. Adjacent nodes sharing an edge with the current child node may have higher priority than adjacent nodes sharing only a vertex with the current child node.

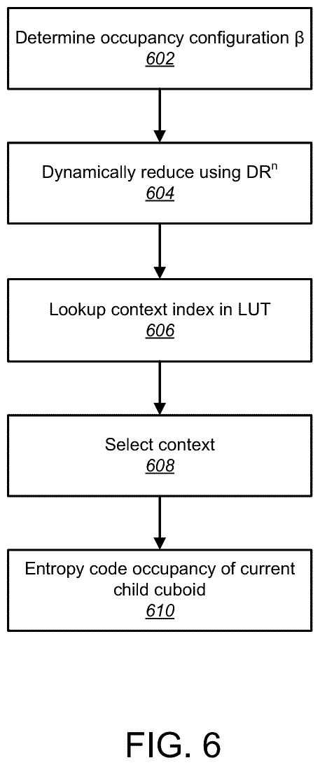

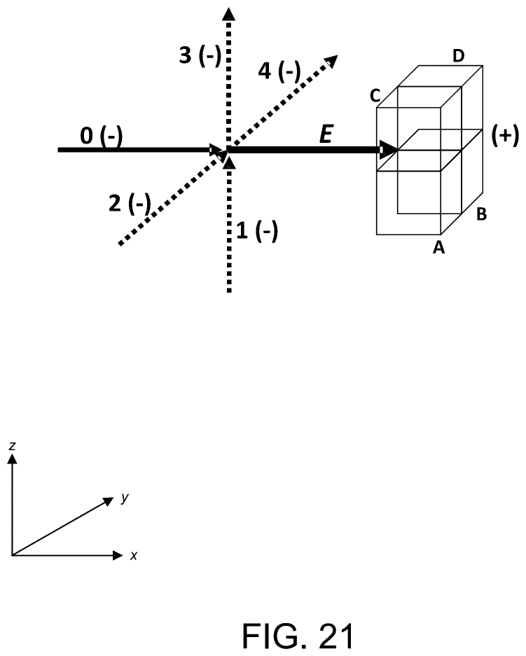

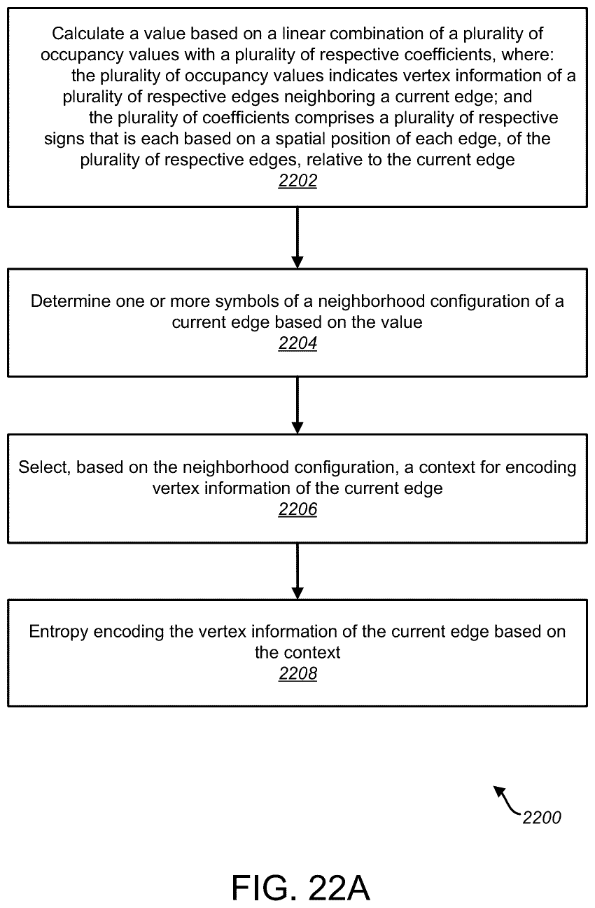

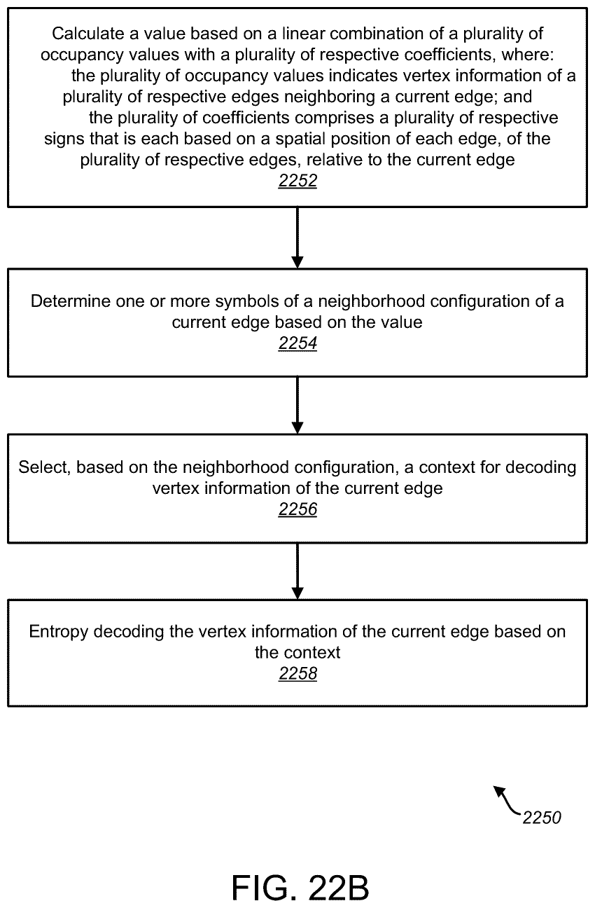

FIG. 6 shows an example method for coding occupancy of a cuboid using dynamic OBUF. More specifically, FIG. 6 shows a flowchart of an example method for coding occupancy (e.g., as indicated by a single bit) of a current child cuboid using dynamic OBUF. More specifically, FIG. 6 shows a flowchart of example method steps coding occupancy of a current child cuboid using dynamic OBUF. The example method, or one or more operations of the method, may be performed by one or more computing devices or entities. For example, all or portions of the flowchart may be implemented by a coder (e.g., encoder 114 in FIG. 1 and/or decoder 120 in FIG. 1), an example computer system 2100 in FIG. 21, and/or an example computing device 2230 in FIG. 22A and FIG. 22B.

At step 602, an encoder and/or decoder may determine the occupancy configuration β of the current child cuboid. The encoder and/or decoder may determine the occupancy configuration β of the current child cuboid, for example, based on occupancy bits of already-coded cuboids in a neighborhood of the current child cuboid. At step 604, the encoder and/or decoder may dynamically reduce the occupancy configuration β into a reduced occupancy configuration using DRⁿ (e.g., β′=DRⁿ(β)). At step 606, the encoder and/or decoder may lookup context index LUT[β′] in the LUT of the dynamic OBUF. At step 608, the encoder and/or decoder may select the context (e.g., probability model) pointed to by the context index. At step 610, the encoder and/or decoder may entropy code (e.g., arithmetic code) the occupancy bit of the current child cuboid based on the context.

Although not shown in FIG. 6, the encoder and/or decoder may further update the reduction function DRⁿ into DRⁿ⁺¹ and/or update the context index LUT[β′] based on the occupancy bit of the current child cuboid. The method of FIG. 6 may be repeated for additional or all child cuboids of parent cuboids corresponding to nodes of the occupancy tree in a scan order, such as the scan order described herein with respect to FIG. 3.

The occupancy tree is a lossless compression technique. The occupancy tree may be adapted to provide lossy compression, for example, by modifying the point cloud on the encoder side (e.g., down-sampling, removing points, moving points, etc.) but compression performance of the lossy compression may be weak. It may be a useful lossless compression technique for dense point clouds.

An approach to lossy compression for point cloud geometry may be to set the maximum depth of the occupancy tree to not reach the smallest volume size of one voxel. Instead, the maximum depth of the occupancy tree may be set to stop at a bigger volume size (e.g., N×N×N cuboids, where N>1). The geometry of the points belonging to each occupied leaf node associated with the bigger volumes may then be modeled. This approach may be particularly suited for dense and smooth point clouds that may be locally modeled by smooth functions, for example, planes or polynomials. The coding cost may become the cost of the occupancy tree plus the cost of the local model in each of the occupied leaf nodes.

A scheme for modeling the geometry of the points belonging to each occupied leaf node associated with a volume size larger than one voxel may use sets of triangles as local models. The scheme may be referred to as the “TriSoup” scheme. TriSoup is short for “Triangle Soup” because the connectivity between triangles may not be part of the models. An occupied leaf node of an occupancy tree that corresponds to a cuboid with a volume greater than one voxel may be referred to as a TriSoup node. An edge belonging to at least one cuboid corresponding to a TriSoup node may be referred to as a TriSoup edge. A TriSoup node may comprise a presence flag (sₖ) for each TriSoup edge of its corresponding occupied cuboid. A presence flag (sₖ) of a TriSoup edge may indicate whether a TriSoup vertex (Vₖ) is present or not on the TriSoup edge. At most one TriSoup vertex (Vₖ) may be present on a TriSoup edge. For each vertex (Vₖ) present on a TriSoup edge of an occupied cuboid, the TriSoup node corresponding to the occupied cuboid may further comprise a position (pₖ) of the vertex (Vₖ) along the TriSoup edge.

In addition to the occupancy words of an occupancy tree, an encoder may entropy encode the TriSoup vertex presence flags and positions of each TriSoup edge belonging to TriSoup nodes of the occupancy tree. A decoder may similarly entropy decode the TriSoup vertex presence flags and positions of each TriSoup edge belonging to a TriSoup node of the occupancy tree, in addition to the occupancy words of the occupancy tree.

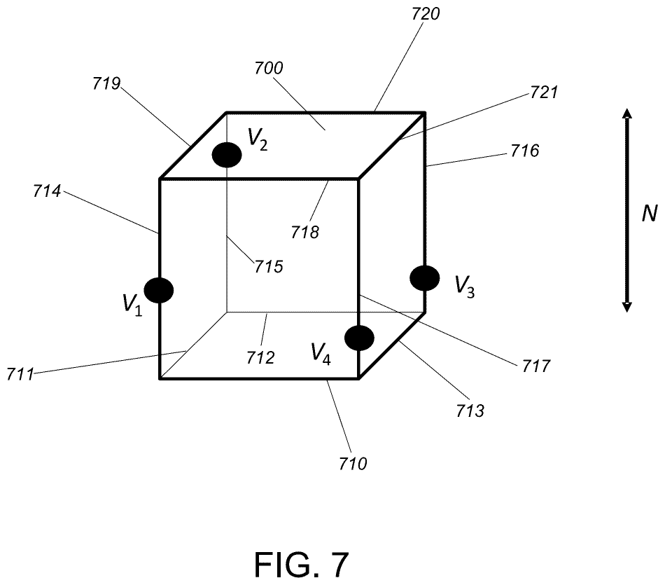

FIG. 7 shows an example of an occupied cuboid 700 that corresponds to a TriSoup node of an occupancy tree. Cuboid 700 may be of size N×N×N (where N>1). Occupied cuboid 700 may comprise TriSoup edges 710-721. The TriSoup node, corresponding to occupied cuboid 700, may comprise a presence flag (sₖ) for each TriSoup edge of TriSoup edges 710-721. The presence flag of TriSoup edge 714 may indicate that a TriSoup vertex V₁ is present on TriSoup edge 714. The presence flag of TriSoup edge 715 may indicate that a TriSoup vertex V₂ is present on TriSoup edge 715. The presence flag of TriSoup edge 716 may indicate that a TriSoup vertex V₃ is present on TriSoup edge 716. The presence flag of TriSoup edge 717 may indicate that a TriSoup vertex V₄ is present on TriSoup edge 717. The presence flags of the remaining TriSoup edges may each indicate that a TriSoup vertex is not present on their corresponding TriSoup edge. The TriSoup node, corresponding to occupied cuboid 700, may further comprise a position for each TriSoup vertex present along one of its TriSoup edges 710-721. More specifically, the TriSoup node, corresponding to occupied cuboid 700, may further comprise a position p₁ for TriSoup vertex V₁, a position p₂ for TriSoup vertex V₂, a position p₃ for TriSoup vertex V₃, and a position p₄ for TriSoup vertex V₄.

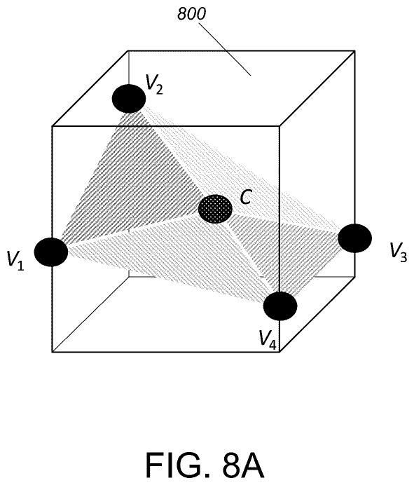

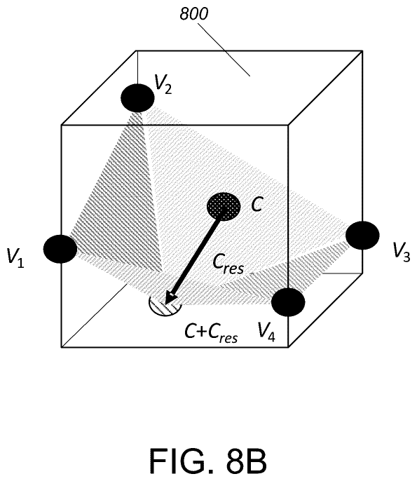

FIG. 8A shows an example cuboid corresponding to a TriSoup node. A cuboid 800 may correspond to a TriSoup node with a number K of TriSoup vertices Vₖ. Within cuboid 800, TriSoup triangles may be constructed from the TriSoup vertices Vₖ. TriSoup triangles may be constructed from the TriSoup vertices Vₖ, for example, if at least three (K≥3) TriSoup vertices are present on the TriSoup edges of cuboid 800. In the example of FIG. 8A, 4 TriSoup vertices are present and TriSoup triangles are constructed. The TriSoup triangles may be constructed around the centroid vertex C. The centroid vertex C may be defined as the mean of the TriSoup vertices Vₖ. A dominant direction may be determined, vertices Vₖ may be ordered by turning around this direction, and the following K TriSoup triangles may be constructed: V₁V₂C, V₂V₃C, . . . , V_{K}V₁C. The dominant direction may be chosen among the three directions respectively parallel to the axes of the 3D space to increase or maximize the 2D surface of the triangles, for example, if the triangles are projected along the dominant direction. The dominant direction may be somewhat perpendicular to a local surface defined by the points of the point cloud belonging to the TriSoup node.

FIG. 8B shows an example refinement to the TriSoup model. The TriSoup model may be refined by coding a centroid residual value. A centroid residual value Cᵣₑₛ may be coded into the bitstream. A centroid residual value Cᵣₑₛ may be coded into the bitstream, for example, to use C+Cᵣₑₛ instead of C as a pivoting vertex for the triangles. By using C+Cᵣₑₛ as the pivoting vertex for the triangles, the vertex C+Cᵣₑₛ may be closer to the points of the point cloud than the centroid C, the reconstruction error may be lowered, thereby leading to lower distortion at the cost of a small increase in bitrate needed for coding Cᵣₑₛ.

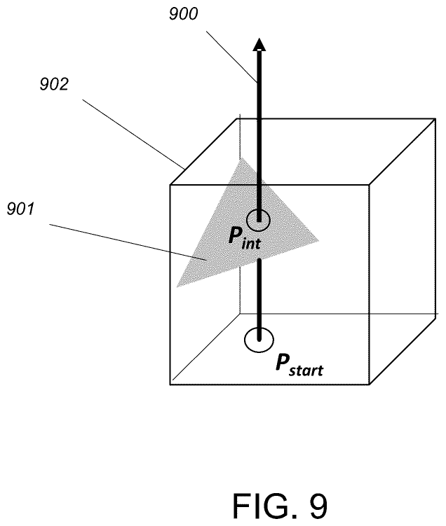

FIG. 9 shows an example of voxelization. Voxelization may refer to reconstruction of a decoded point cloud from the set of TriSoup triangles. Voxelization may be performed by ray tracing for each triangle individually. Voxelization may be performed by ray tracing for each triangle individually, for example, before removing duplicated points between voxelized triangles. As shown in FIG. 9, rays 900 may be launched parallel to one of the three axes of the 3D space. Rays 900 may be launched starting from integer coordinates Pₛₜₐᵣₜ. The intersection Pᵢₙₜ (if any) of the rays 900 with a TriSoup triangle 901 belonging to a cuboid 902 corresponding to a TriSoup node may be rounded to obtain a decoded point. This intersection Pᵢₙₜ may be found, for example, using the Möller-Trumbore algorithm.

A presence flag (sₖ) and, if the presence flag (sₖ) indicates the presence of a vertex, a position (pₖ) of a current TriSoup edge may be entropy coded. The presence flag (sₖ) and position (pₖ) may be individually or collectively referred to as vertex information. A presence flag (sₖ) and, if the presence flag (sₖ) indicates the presence of a vertex, a position (pₖ) of a current TriSoup edge may be entropy coded, for example, based on already-coded presence flags and positions of TriSoup edges that neighbor the current TriSoup edge. A presence flag (sₖ) and, if the presence flag (sₖ) indicates the presence of a vertex, a position (pₖ) of a current TriSoup edge may be additionally or alternatively entropy coded. The presence flag (sₖ) and the position (pₖ) of a current TriSoup edge may be additionally or alternatively entropy coded, for example, based on occupancies of cuboids that neighbor the current TriSoup edge. Similar to the entropy coding of the occupancy bits of the occupancy tree, a configuration β_{TS} for a neighborhood (also referred to as a neighborhood configuration β_{TS}) of a current TriSoup edge may be obtained and dynamically reduced into a reduced configuration β_{TS}′=DRⁿ(β_{TS}). The configuration β_{TS} for a neighborhood of a current TriSoup edge may be obtained and dynamically reduced into a reduced configuration β_{TS}′=DRⁿ(β_{TS}), for example, by using a dynamic OBUF scheme for TriSoup. A context index LUT[β_{TS}′] may be obtained from the OBUF LUT. At least a part of the vertex information of the current TriSoup edge may be entropy coded using the context (e.g., probability model) pointed to by the context index.

The TriSoup vertex position (pₖ) (if present) along its TriSoup edge may be binarized. The TriSoup vertex position (pₖ) (if present) along its TriSoup edge may be binarized, for example, to use a binary entropy coder to entropy code at least part of the vertex information of the current TriSoup edge. A number (e.g., quantity) of bits N_{b} may be set for the quantization of the TriSoup vertex position (pₖ) along the TriSoup edge of length N. The TriSoup edge of length N may be uniformly divided into 2^{Nb} quantization intervals. By doing so, the TriSoup vertex position (pₖ) may be represented by N_{b} bits (pₖ^{j}, j=1, . . . , N_{b}) that may be individually coded by the dynamic OBUF scheme as well as the bit corresponding to the presence flag (sₖ). The neighborhood configuration β_{TS}, the OBUF reduction function DRⁿ, and thus the context index may depend on the nature of the coded bit (e.g., presence flag (sₖ), highest position bit (pₖ¹), second highest position bit (pₖ²), etc.). There may be several dynamic OBUF schemes, each dedicated to a specific bit of information (e.g., presence flag (sₖ) or position bit (pₖ^{j})) of the vertex information.

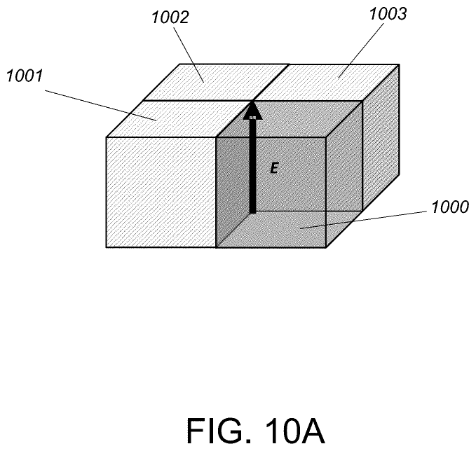

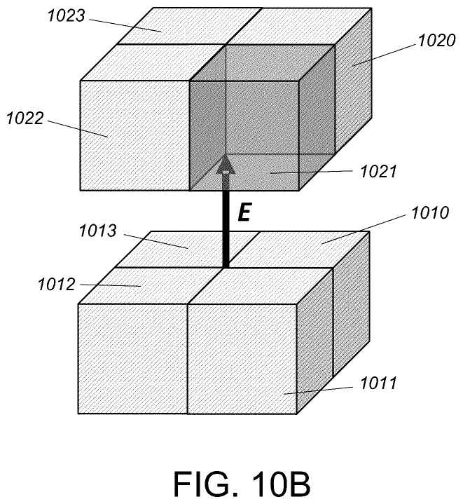

FIG. 10A and FIG. 10B show 12 cuboids 1000-1003, 1010-1013, and 1020-1023 with volumes that intersect a current TriSoup edge E being entropy coded. Current TriSoup edge E is an edge of cuboids 1000-1003. The start point of current TriSoup edge E intersects cuboids 1010-1013. The end point of current TriSoup edge E intersects cuboids 1020-1023. The occupancy bits of one or more of the 12 cuboids 1000-1003, 1010-1013, and 1020-1023 may be used to determine the neighborhood configuration β_{TS} for current TriSoup edge E.

TriSoup edges may be oriented from a start point to an end point following the orientation of one of the three axes of the 3D space they are parallel to. A global ordering of the TriSoup edges may be defined as the lexicographic order over the couple (e.g., start point, end point). Vertex information related to the TriSoup edges may be coded following the TriSoup edge ordering. A causal neighborhood of a current TriSoup edge may be obtained from the neighboring already-coded TriSoup edges of the current TriSoup edge.

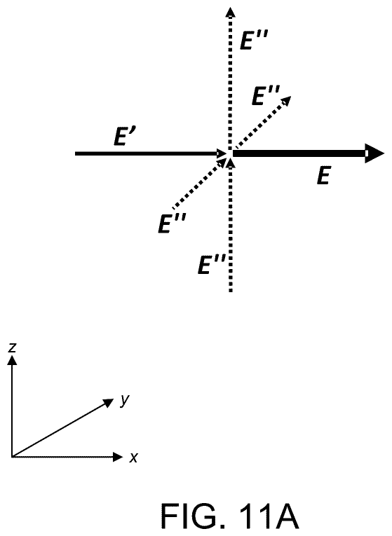

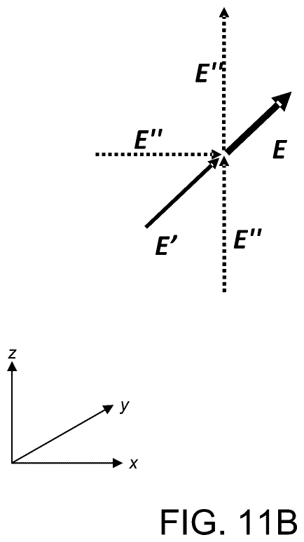

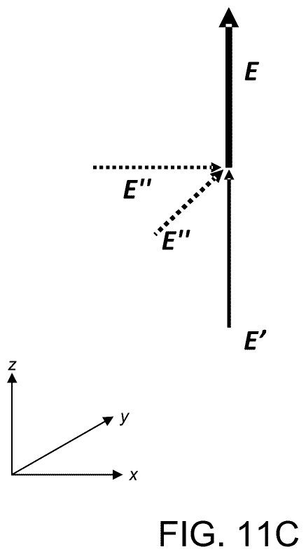

FIG. 11A, FIG. 11B, and FIG. 11C show TriSoup edges (E′ and E″) that may be used to entropy code a current edge E. In some instances, at most five TriSoup edges (E′ and E″) may be used to entropy code a current edge E. The five TriSoup edges may include,
the edge E′ parallel to the current TriSoup edge E and having an end point equal to the start point of the current TriSoup edge E, and
the four edges E″ perpendicular to the current TriSoup edge E and having a start or end point equal to the start point of the current TriSoup edge E.

Depending on the direction of current TriSoup edge E, either two (FIG. 11C for direction z), three (FIG. 11B for direction y), or four (FIG. 11A for direction x) of the four perpendicular TriSoup edges may have been already coded and their vertex information may be used to construct the neighborhood configuration β_{TS} for current TriSoup edge E. The TriSoup edge E′ may have already been coded for each direction of the current TriSoup edge E and its vertex information may be used to construct the neighborhood configuration β_{TS} for current TriSoup edge E independent of its direction.

As described herein, the neighborhood configuration β_{TS} for a current TriSoup edge E may be obtained from one or more occupancy bits of cuboids and from the vertex information of neighboring already-coded TriSoup edges. The neighborhood configuration β_{TS} for a current TriSoup edge E may be obtained from one or more of the 12 occupancy bits of the 12 cuboids shown in FIG. 10A and FIG. 10B and from the vertex information of the at most five neighboring already-coded TriSoup edges (E′ and E″) shown in FIG. 11A, 11B, and 11C.

As described herein with respect to FIG. 11A, 11B, and 11C, the vertex information of at most five TriSoup edges may be used to entropy code a current TriSoup edge E. More particularly, as described herein with respect to FIG. 11A, 11B, and 11C, the vertex information of at most five TriSoup edges may be used to determine the neighborhood configuration β_{TS} of the current TriSoup edge E. The neighborhood configuration β_{TS} may be dynamically reduced into a reduced configuration β_{TS}′=DRⁿ(β_{TS}). The neighborhood configuration β_{TS} may be dynamically reduced into a reduced configuration β_{TS}′=DRⁿ(β_{TS}), for example, by using a dynamic OBUF scheme as described herein. A context index LUT[β_{TS}′] may be obtained from the OBUF LUT and at least a part of the vertex information of the current TriSoup edge E may be entropy coded using the context (e.g., probability model) pointed to by the context index.

Using the vertex information of the at most five TriSoup edges to entropy code the current TriSoup edge E may result in a weak correlation between the neighborhood configuration β_{TS} and the vertex information of current TriSoup edge E. The dynamic OBUF scheme may provide a context index for entropy coding the current TriSoup edge E with coding probabilities that are weakly correlated with the vertex information of the current TriSoup edge E. Because of this weak correlation, the vertex information of the current TriSoup edge E may not be effectively compressed.

The disclosures provided herein improve the correlation between the neighborhood configuration β_{TS} of a current TriSoup edge E and the vertex information of the current TriSoup edge E. The improved correlation may allow the vertex information of the current TriSoup edge E to be more effectively compressed using entropy coding. The improved compression using entropy coding may lead to smaller storage requirement, faster and more efficient transmission of point cloud data, and faster and more efficient processing of the point cloud data. This can result in a better experience in and wider adoption of volumetric visual data applications such as AR, VR, MR, and many others, as well as advancement in any hardware implementation of such technologies. As described herein, an encoder and/or decoder may determine one or more symbols of a neighborhood configuration β_{TS} of the current TriSoup edge E. The encoder and/or decoder may determine one or more symbols of a neighborhood configuration β_{TS} of the current TriSoup edge E, for example, based on at least one TriSoup edge that, unlike the at most five TriSoup edges shown in FIG. 11A, FIG. 11B, and 11C, does not intersect a start point of the current TriSoup edge E. The vertex information of this at least one TriSoup edge may be used to determine (e.g., in conjunction with one or more of the at least five TriSoup edges shown in FIG. 11A, FIG. 11B, and 11C) one or more symbols of the neighborhood configuration β_{TS} with the improved correlation. The encoder and/or decoder may select a context (e.g., probability model) for coding the vertex information of the current TriSoup edge E. The encoder and/or decoder may select a context (e.g., probability model) for coding the vertex information of the current TriSoup edge E, for example, based on the neighborhood configuration β_{TS} with the improved correlation. The encoder and/or decoder may select the context for coding the vertex information of the current TriSoup edge E, for example, based on a reduced configuration β_{TS}′=DRⁿ(β_{TS}) representing a subset of the symbols of the neighborhood configuration β_{TS}. The encoder and/or decoder may select the context based on an OBUF LUT that maps the neighborhood configuration β_{TS} or the reduced configuration β_{TS}′ to an index of the context. The encoder and/or decoder may entropy code (e.g., arithmetic code) the vertex information of the current TriSoup edge E. The encoder and/or decoder may entropy code (e.g., arithmetic code) the vertex information of the current TriSoup edge E, for example, based on the context.

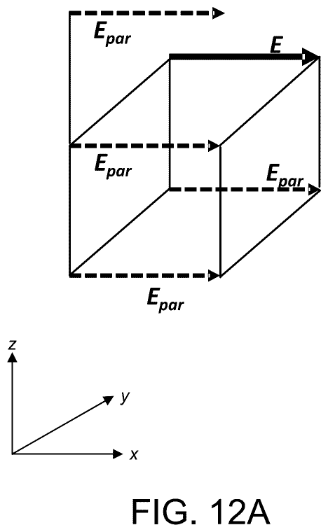

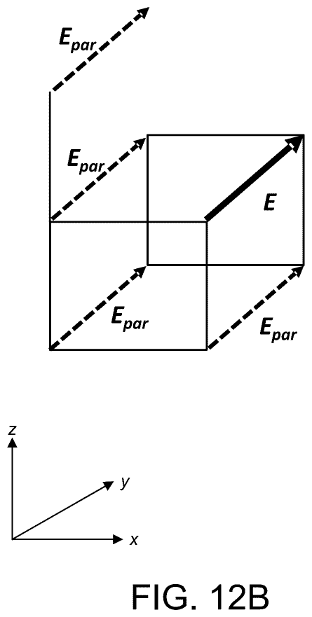

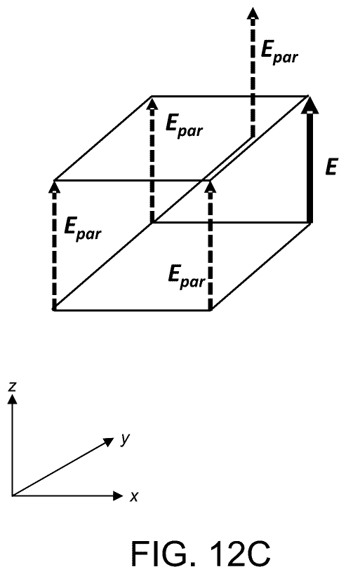

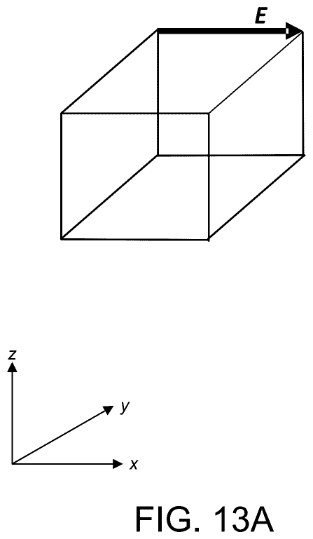

FIG. 12A, FIG. 12B, and FIG. 12C show neighboring already-coded TriSoup edges that neighbor and do not intersect a start point of a current TriSoup edge E. The current TriSoup edge E may be a TriSoup edge being entropy coded. The neighboring already-coded TriSoup edges shown in FIG. 12A, FIG. 12B, and FIG. 12C do not intersect a start point of a current TriSoup edge E being entropy coded, unlike the at most five TriSoup edges shown in FIG. 11A, FIG. 11B, and 11C. More particularly, FIG. 12A, FIG. 12B, and FIG. 12C show neighboring already-coded TriSoup edges Eₚₐᵣ that are parallel to the current TriSoup edge E and belong to a same TriSoup node as the current TriSoup edge E.

FIG. 12A shows already-coded parallel edges Eₚₐᵣ that are available for coding a current TriSoup edge E. The already-coded parallel edges Eₚₐᵣ may be available for coding a current TriSoup edge E, for example, based on the current TriSoup edge E being parallel to the x direction. FIG. 12B shows already-coded parallel edges Eₚₐᵣ that are available for coding a current TriSoup edge E. The already-coded parallel edges Eₚₐᵣ may be available for coding a current TriSoup edge E, for example, based on the current TriSoup edge E being parallel to the y direction. FIG. 12C shows already-coded parallel edges Eₚₐᵣ that are available for coding a current TriSoup edge E. The already-coded parallel edges Eₚₐᵣ may be available for coding a current TriSoup edge E, for example, based on the current TriSoup edge E being parallel to the z direction. These parallel edges Eₚₐᵣ may already be coded according to the lexicographic order, as described herein, that globally orders the set of TriSoup edges.

An encoder and/or decoder may determine one or more symbols of a neighborhood configuration β_{TS} of a current TriSoup edge E. The encoder and/or decoder may determine one or more symbols of a neighborhood configuration β_{TS} of a current TriSoup edge E, for example, based on one or more of the already-coded four parallel edges Eₚₐᵣ shown in FIG. 12A, FIG. 12B, and FIG. 12C that may be available for coding the current TriSoup edge E. The specific set of already-coded four parallel edges Eₚₐᵣ shown in FIG. 12A, FIG. 12B, and FIG. 12C that may be available for coding the current TriSoup edge E may be determined, for example, based on the direction to which the current TriSoup edge E is parallel as described herein. The vertex information of the one or more of the already-coded four parallel edges Eₚₐᵣ may be used to determine (e.g., in conjunction with one or more of the at least five TriSoup edges shown in FIG. 11A, FIG. 11B, and 11C) one or more symbols of a neighborhood configuration β_{TS} of the current TriSoup edge E. The encoder and/or decoder may select a context (e.g., probability model) for coding the vertex information of the current TriSoup edge E. The encoder and/or decoder may select a context (e.g., probability model) for coding the vertex information of the current TriSoup edge E, for example, based on the neighborhood configuration β_{TS}. The encoder and/or decoder may select the context for coding the vertex information of the current TriSoup edge E. The encoder and/or decoder may select the context for coding the vertex information of the current TriSoup edge E, for example, based on a reduced configuration β_{TS}′=DRⁿ(β_{TS}) representing a subset of the symbols of the neighborhood configuration β_{TS}. The encoder and/or decoder may select the context, for example, based on an OBUF LUT that maps the neighborhood configuration β_{TS} or the reduced configuration β_{TS}′ to an index of the context. The encoder and/or decoder may entropy code (e.g., arithmetic code) the vertex information of the current TriSoup edge E, for example, based on the context.

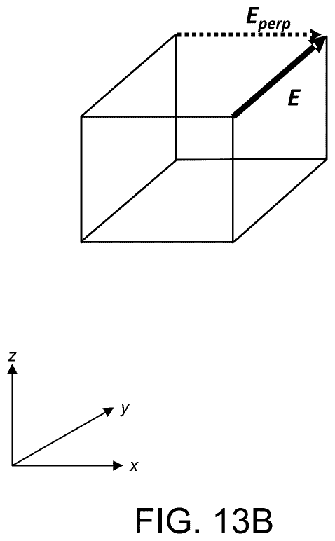

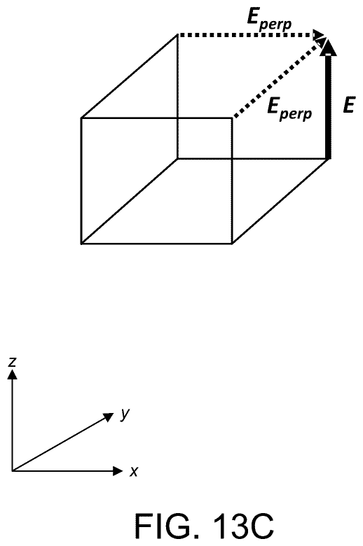

FIG. 13A, FIG. 13B, and FIG. 13C show already-coded TriSoup edges that neighbor and do not intersect a start point of a current TriSoup edge. The neighboring already-coded TriSoup edges shown in FIG. 13A, FIG. 13B, and FIG. 13C do not intersect a start point of a current TriSoup edge E being entropy coded, unlike the at most five TriSoup edges shown in FIG. 11A, FIG. 11B, and 11C. More particularly, FIG. 13A, FIG. 13B, and FIG. 13C show neighboring already-coded TriSoup edges Eₚₑᵣₚ that may be perpendicular to the current TriSoup edge E and intersect the end point of the current TriSoup edge E.

FIG. 13A shows that no already-coded perpendicular edges Eₚₑᵣₚ may be available for coding a current TriSoup edge E based on the current TriSoup edge E being parallel to the x axis. FIG. 13B shows that one already-coded perpendicular edge Eₚₑᵣₚ may be available for coding a current TriSoup edge E based on the current TriSoup edge E being parallel to the y axis. FIG. 13C shows that two already-coded perpendicular edges Eₚₑᵣₚ may be available for coding a current TriSoup edge E based on the current TriSoup edge E being parallel to the z axis. These perpendicular edges Eₚₑᵣₚ may already be coded according to the lexicographic order, as described here, that globally orders the set of TriSoup edges.

An encoder and/or decoder may determine one or more symbols of a neighborhood configuration β_{TS} of a current TriSoup edge E. An encoder and/or decoder may determine one or more symbols of a neighborhood configuration β_{TS} of a current TriSoup edge E, for example, based on one or more of the already-coded perpendicular edges Eₚₑᵣₚ shown in FIG. 13A, FIG. 13B, and FIG. 13C that are available for coding the current TriSoup edge E. The specific set of already-coded perpendicular edges Eₚₑᵣₚ shown in FIG. 13A, FIG. 13B, and FIG. 13C that may be available for coding the current TriSoup edge E may be determined, for example, based on the direction to which the current TriSoup edge E is parallel as described herein. The vertex information of the one or more of the already-coded perpendicular edges Eₚₑᵣₚ may be used to determine (e.g., in conjunction with one or more of the at least five TriSoup edges shown in FIG. 11A, FIG. 11B, and 11C and/or in conjunction with one or more of the already-coded four parallel edges Eₚₐᵣ shown in FIG. 12A, FIG. 12B, and FIG. 12C) one or more symbols of a neighborhood configuration β_{TS} of the current TriSoup edge E. The encoder and/or decoder may select a context (e.g., probability model) for coding the vertex information of the current TriSoup edge E. The encoder and/or decoder may select a context (e.g., probability model) for coding the vertex information of the current TriSoup edge E, for example, based on the neighborhood configuration β_{TS}. The encoder and/or decoder may select the context for coding the vertex information of the current TriSoup edge E. The encoder and/or decoder may select the context for coding the vertex information of the current TriSoup edge E, for example, based on a reduced configuration β_{TS}′=DRⁿ(β_{TS}) representing a subset of the symbols of the neighborhood configuration β_{TS}. The encoder and/or decoder may select the context based on an OBUF LUT. The OBUF LUT may map the neighborhood configuration β_{TS} or the reduced configuration β_{TS}′ to an index of the context. The encoder and/or decoder may entropy code (e.g., arithmetic code) the vertex information of the current TriSoup edge E based on the context.

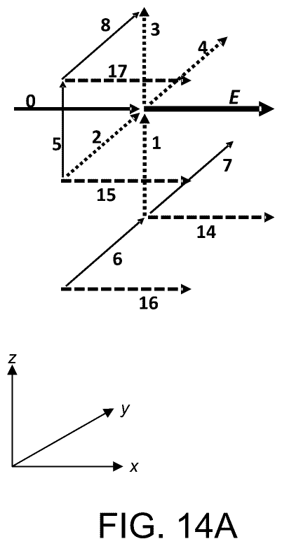

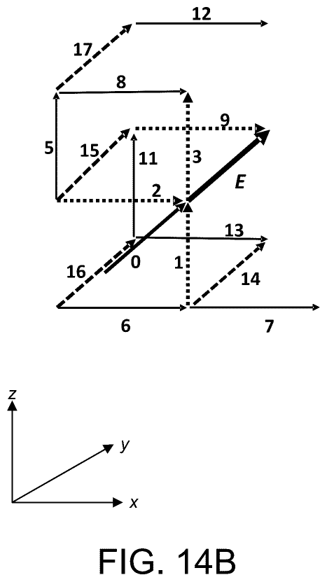

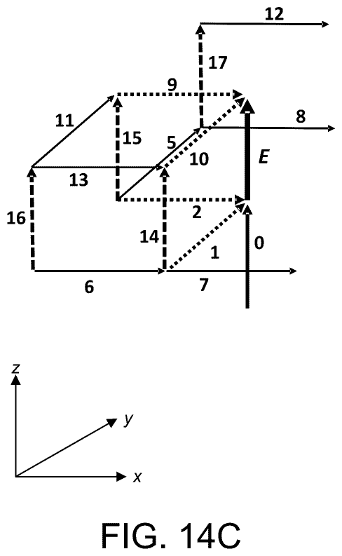

FIG. 14A, FIG. 14B, and FIG. 14C show neighboring already coded edges of a current TriSoup edge E. The neighboring already coded edges may be taken from a spatial topology, of a current TriSoup edge E. The neighboring already coded edges may be taken from a spatial topology of 18 edges (e.g., labeled from 0 to 17). The current TriSoup edge E may be parallel: to the x direction (FIG. 14A), to the y direction (FIG. 14B), or to the z direction (FIG. 14C). Edge 0 may correspond to the unique edge (E′ in FIG. 11) parallel to the current TriSoup edge E and having its end point equal to (e.g., coinciding with) the start point of the current TriSoup edge E. Edges 1, 2, 3, 4 may correspond to the at most four edges (E″ in FIG. 11A, FIG. 11B, and 11C) perpendicular to the current TriSoup edge E and having a start or end point equal to (e.g., coinciding with) the start point of the current TriSoup edge E. Edges 14, 15, 16, 17 may be edges (Eₚₐᵣ in FIG. 12A, FIG. 12B, and FIG. 12C) that are parallel to the current TriSoup edge E and belong to a same TriSoup node as the current TriSoup edge E. Edges 9, 10 may be edges (Eₚₑᵣₚ in FIG. 13A, FIG. 13B, and FIG. 13C) that are perpendicular to the current TriSoup edge E and intersect the end point of the current TriSoup edge E. Edges 1, 2, 3, 4, 5, 6, 7, 8 may belong to a same TriSoup node as the current TriSoup edge E and may belong to the plane: perpendicular to the current TriSoup edge E, and comprising the start point of the current TriSoup edge E. Edges 9, 10, 11, 12, 13 may belong to a same TriSoup node as the current TriSoup edge E and belong to the plane: perpendicular to the current TriSoup edge E, and comprising the end point of the current TriSoup edge E.

An encoder and/or decoder may determine one or more symbols of a neighborhood configuration β_{TS} of a current TriSoup edge E. encoder and/or decoder may determine one or more symbols of a neighborhood configuration β_{TS} of a current TriSoup edge E, for example, based on one or more of the already-coded edges 0 to 17 shown in FIG. 14A, FIG. 14B, and FIG. 14C that are available for coding the current TriSoup edge E. The specific set of the already-coded edges 0 to 17 shown in FIG. 14A, FIG. 14B, and FIG. 14C that may be available for coding the current TriSoup edge E may be determined, for example, based on the direction to which the current TriSoup edge E is parallel. The vertex information of the one or more of the already-coded edges 0 to 17 may be used to determine one or more symbols of a neighborhood configuration β_{TS} of the current TriSoup edge E. The encoder and/or decoder may select a context (e.g., probability model) for coding the vertex information of the current TriSoup edge E. The encoder and/or decoder may select a context (e.g., probability model) for coding the vertex information of the current TriSoup edge E, for example, based on the neighborhood configuration β_{TS}. The encoder and/or decoder may select the context for coding the vertex information of the current TriSoup edge E. The encoder and/or decoder may select the context for coding the vertex information of the current TriSoup edge E, for example, based on a reduced configuration β_{TS}′=DRⁿ(β_{TS}) representing a subset of the symbols of the neighborhood configuration β_{TS}. The encoder and/or decoder may select the context. The encoder and/or decoder may select the context, for example, based on an OBUF LUT that maps the neighborhood configuration β_{TS} or the reduced configuration β_{TS}′ to an index of the context. The encoder and/or decoder may entropy code (e.g., arithmetic code) the vertex information of the current TriSoup edge E. The encoder and/or decoder may entropy code (e.g., arithmetic code) the vertex information of the current TriSoup edge E, for example, based on the context.

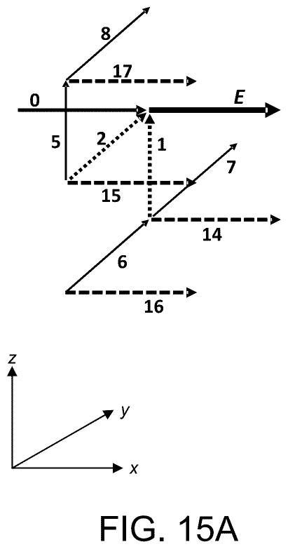

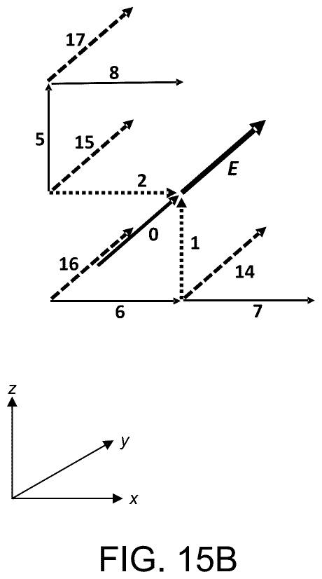

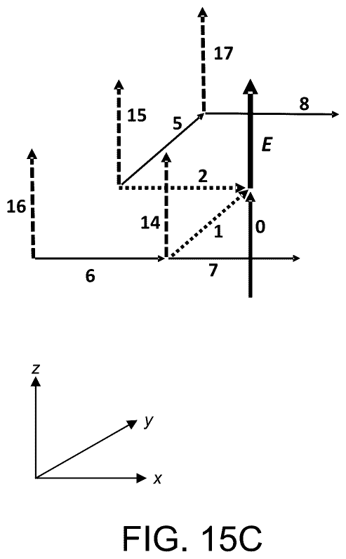

The spatial topology of 18 edges shown in FIG. 14A, FIG. 14B, and FIG. 14C may include sub-spatial topologies of edges. Each edge of the sub-spatial topologies of edges may be available (e.g., already coded) for coding a current TriSoup edge E independent of a direction to which the current TriSoup edge E is parallel. FIG. 15A, FIG. 15B, and FIG. 15C show an example of a sub-spatial topology of TriSoup edges. The sub-spatial topology of TriSoup edges may be, for example, an 18-edge spatial topology as shown in FIG. 14A, FIG. 14B, and FIG. 14C. The sub-spatial topology of edges may comprise the 11 edges 0, 1, 2, 5, 6, 7, 8, 14, 15, 16, 17. FIG. 15A, FIG. 15B, and FIG. 15C show that, for each of the three possible directions of the current TriSoup edge E, each of the 11 edges of the sub-spatial topology of edges may be available for coding the current TriSoup edge E. FIG. 15A shows that each of the 11 edges of the sub-spatial topology of edges may be available for coding the current TriSoup edge E, for example, if current TriSoup edge E is parallel to the x axis. FIG. 15B shows that each of the 11 edges of the sub-spatial topology of edges may be available for coding the current TriSoup edge E parallel to the y axis. FIG. 15C shows that each of the 11 edges of the sub-spatial topology of edges may be available for coding the current TriSoup edge E parallel to the z axis.

A different configuration of the sub-spatial topology may be used for each direction of current TriSoup edge E. The different configurations may comprise different rotated and/or mirrored configurations of the sub-spatial topology of edges. The sub-spatial topology of edges in FIG. 15A may be rotated by 90 degrees in two different directions (e.g., rotated around the y axis and rotated around the z axis) relative to the sub-spatial topology of edges in FIG. 15C. The sub-spatial topology of edges in FIG. 15A may be rotated by 90 degrees (e.g., around the z axis) and mirrored (e.g., over the x-z plane) relative to the sub-spatial topology of edges in FIG. 15B.

An encoder and/or decoder may determine one or more symbols of a neighborhood configuration β_{TS} of a current TriSoup edge E. An encoder and/or decoder may determine one or more symbols of a neighborhood configuration β_{TS} of a current TriSoup edge E, for example, based on edges only belonging to the sub-spatial topology of edges shown in FIG. 15A, FIG. 15B, and FIG. 15C that are available for coding the current TriSoup edge E independent of its direction (e.g., independent of a direction to which the current TriSoup edge E is parallel). The encoder and/or decoder may select a context (e.g., probability model) for coding the vertex information of the current TriSoup edge E. The encoder and/or decoder may select a context (e.g., probability model) for coding the vertex information of the current TriSoup edge E, for example, based on the neighborhood configuration β_{TS}. The encoder and/or decoder may select the context for coding the vertex information of the current TriSoup edge E. The encoder and/or decoder may select the context for coding the vertex information of the current TriSoup edge E, for example, based on a reduced configuration β_{TS}′=DRⁿ(β_{TS}). The reduced configuration β_{TS}′=DRⁿ(β_{TS}) may represent a subset of the symbols of the neighborhood configuration β_{TS}. The encoder and/or decoder may select the context based on an OBUF LUT that maps the neighborhood configuration β_{TS} or the reduced configuration β_{TS}′ to an index of the context. The encoder and/or decoder may entropy code (e.g., arithmetic code) the vertex information of the current TriSoup edge E. The encoder and/or decoder may entropy code (e.g., arithmetic code) the vertex information of the current TriSoup edge E, for example, based on the context.

A spatial topology of edges may be referred to as a direction-independent spatial-topology of edges. Each edge of the spatial topology of edges may be available (e.g., already coded) for coding a current TriSoup edge E independent of a direction of the current TriSoup edge E.

Dilution of the dynamic OBUF statistics by having a unique set of statistics for all three directions of a current TriSoup edge E may be reduced or avoided. Dilution of the dynamic OBUF statistics by having a unique set of statistics for all three directions of a current TriSoup edge E may be reduced or avoided, for example, by determining one or more symbols of a neighborhood configuration β_{TS} of a current TriSoup edge E based on edges only belonging to a direction-independent spatial-topology of edges. The one or more symbols of a neighborhood configuration β_{TS} of a current TriSoup edge E may be determined based on edges only belonging to a direction-independent spatial-topology of edges, for example, like the sub-spatial topology of edges shown in FIG. 15A, FIG. 15B, and FIG. 15C. This may lead to faster convergence of the OBUF LUT of context indices, and result in more efficient compression of the vertex information of the current TriSoup edge E.

An encoder and/or decoder implementation may determine one or more symbols of a neighborhood configuration β_{TS} of a current TriSoup edge E based on edges only belonging to a direction-independent spatial-topology of edges. In this implementation, the encoder and/or decoder may split the neighborhood configuration β_{TS} into at least three series of bits

β_{TS}=(β_{ind},dir,β_{dep})

β_{ind} is the one or more symbols of the neighborhood configuration β_{TS} determined based on edges only belonging to a direction-independent spatial-topology of edges, dir is the direction of the current edge, and β_{dep} is one or more symbols of the neighborhood configuration β_{TS} determined based on at least one edge that is not available to code the current TriSoup edge E independent of a direction of the current TriSoup edge E. The one or more symbols β_{ind} may be determined, for example, based on edges only belonging to the sub-spatial topology of edges shown in FIG. 15A, FIG. 15B, and FIG. 15C. β_{dep} may be determined, for example, based on edges belonging to the spatial topology of edges shown in FIG. 14A, FIG. 14B, and FIG. 14C that do not belong to the sub-spatial topology of edges shown in FIG. 15A, FIG. 15B, and FIG. 15C. The direction dir may be made of two bits, for example: 00 for x, 01 for y, 10 for z, and 11 may be unused. The encoder and/or decoder may start coding information by dynamic OBUF. The encoder and/or decoder may start coding information by dynamic OBUF, for example, by using the leftmost bits β_{ind} of the neighborhood configuration β_{TS} that shares the same statistics independent of the direction of the current TriSoup edge E. This may help dynamic OBUF converge faster in its early phase. More bits of the neighborhood configuration β_{TS} may be unmasked. More bits of the neighborhood configuration β_{TS} may be unmasked, for example, during the evolution of the coding. The statistics may be distributed, for example, if the two bits of dir are unmasked, through the OBUF tree, among the three directions of the current TriSoup edge E to take into account the direction-dependent topology of the remaining neighborhood that has been used to construct β_{dep}.

The advantage of the direction-independent spatial-topology of edges may be realized, for example, if the geometry of the point cloud is spatially isotropic at the scale of the spatial-topology. Sharing statistics among directions may not be desirable because the statistics may not fundamentally depend on the direction. This condition may be fulfilled because the local (e.g., at the scale of the size of a TriSoup node) geometry of a point cloud may be generally isotropic for reasonable TriSoup node sizes.

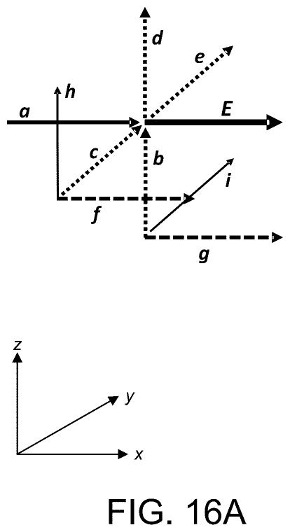

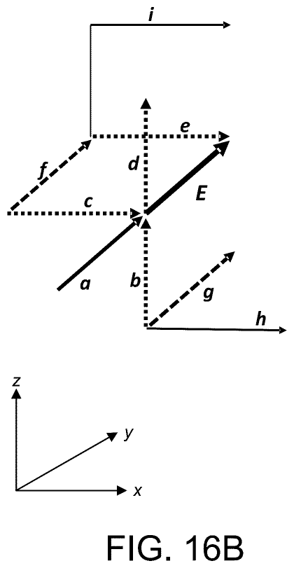

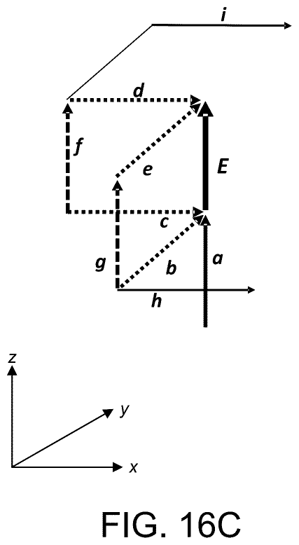

FIG. 16A, FIG. 16B, and FIG. 16C show neighboring already coded edges. The neighboring already coded edges may be taken from a spatial topology of 9 edges of a current TriSoup edge E. The 9 edges of the spatial topology may be labeled a to i. The current TriSoup edge E may be parallel: to the x direction (FIG. 16A), to the y direction (FIG. 16B), or to the z direction (FIG. 16C). The spatial topology of 9 edges shown in FIG. 16A, FIG. 16B, and FIG. 16C may be used as an alternative to the spatial topology of 18 edges shown in FIG. 14A, FIG. 14B, and FIG. 14C. By being smaller than the spatial topology of 18 edges shown in FIG. 14A, FIG. 14B, and FIG. 14C, the spatial topology of 9 edges shown in FIG. 16A, FIG. 16B, and FIG. 16C may be easier to compute but offer less correlations and thus worse compression performance.

An encoder and/or decoder may determine one or more symbols of a neighborhood configuration β_{TS} of a current TriSoup edge E. An encoder and/or decoder may determine one or more symbols of a neighborhood configuration β_{TS} of a current TriSoup edge E, for example, based on one or more of the already-coded edges a to i shown in FIG. 16A, FIG. 16B, and FIG. 16C that may be available for coding the current TriSoup edge E. The specific set of the already-coded edges a to i shown in FIG. 16A, FIG. 16B, and FIG. 16C that may be available for coding the current TriSoup edge E may be determined. The specific set of the already-coded edges a to i shown in FIG. 16A, FIG. 16B, and FIG. 16C that may be available for coding the current TriSoup edge E may be determined, for example, based on the direction to which the current TriSoup edge E is parallel. The vertex information of the one or more of the already-coded edges a to i may be used to determine one or more symbols of a neighborhood configuration β_{TS} of the current TriSoup edge E. The encoder and/or decoder may select a context (e.g., probability model) for coding the vertex information of the current TriSoup edge E. The encoder and/or decoder may select a context (e.g., probability model) for coding the vertex information of the current TriSoup edge E, for example, based on the neighborhood configuration β_{TS}. The encoder and/or decoder may select the context for coding the vertex information of the current TriSoup edge E. The encoder and/or decoder may select the context for coding the vertex information of the current TriSoup edge E, for example, based on a reduced configuration β_{TS}′=DRⁿ(β_{TS}) representing a subset of the symbols of the neighborhood configuration β_{TS}. The encoder and/or decoder may select the context based on an OBUF LUT that maps the neighborhood configuration β_{TS} or the reduced configuration β_{TS}′ to an index of the context. The encoder and/or decoder may entropy code (e.g., arithmetic code) the vertex information of the current TriSoup edge E based on the context.

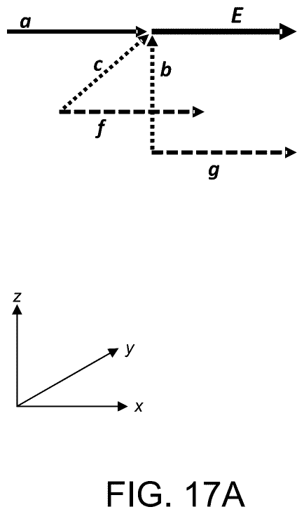

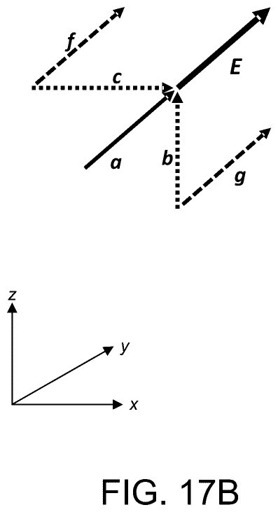

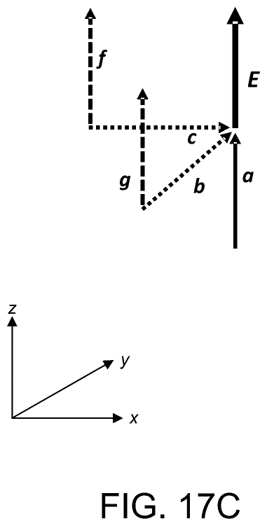

The spatial topology of 9 edges shown in FIG. 16A, FIG. 16B, and FIG. 16C may include sub-spatial topologies of edges. Each edge of the sub-spatial topologies of edges may be available (e.g., already coded) for coding a current TriSoup edge E independent of a direction to which the current TriSoup edge E is parallel. FIG. 17A, FIG. 17B, and FIG. 17C show an example of a sub-spatial topology of TriSoup edges. The sub-spatial topology of TriSoup edges may comprise 5 edges a, b, c, f, g of the 9-edge spatial topology shown in FIG. 16A, FIG. 16B, and FIG. 16C. FIG. 17A, FIG. 17B, and FIG. 17C show that, for each of the three possible directions of the current TriSoup edge E, each of the 5 edges of the sub-spatial topology of edges may be available for coding the current TriSoup edge E. FIG. 17A shows that each of the 5 edges of the sub-spatial topology of edges may be available for coding the current TriSoup edge E, for example, if current TriSoup edge E is parallel to the x axis. FIG. 17B shows that each of the 5 edges of the sub-spatial topology of edges may be available for coding the current TriSoup edge E parallel to the y axis. FIG. 17C shows that each of the 5 edges of the sub-spatial topology of edges may be available for coding the current TriSoup edge E parallel to the z axis.

An encoder and/or decoder may determine one or more symbols of a neighborhood configuration β_{TS} of a current TriSoup edge E. An encoder and/or decoder may determine one or more symbols of a neighborhood configuration β_{TS} of a current TriSoup edge E, for example, based on edges only belonging to the sub-spatial topology of edges shown in FIG. 17A, FIG. 17B, and FIG. 17C that may be available for coding the current TriSoup edge E independent of its direction (e.g., independent of a direction to which the current TriSoup edge E is parallel). The encoder and/or decoder may select a context (e.g., probability model) for coding the vertex information of the current TriSoup edge E. The encoder and/or decoder may select a context (e.g., probability model) for coding the vertex information of the current TriSoup edge E, for example, based on the neighborhood configuration β_{TS}. The encoder and/or decoder may select the context for coding the vertex information of the current TriSoup edge E. The encoder and/or decoder may select the context for coding the vertex information of the current TriSoup edge E, for example, based on a reduced configuration β_{TS}′=DRⁿ(β_{TS}) representing a subset of the symbols of the neighborhood configuration β_{TS}. The encoder and/or decoder may select the context based on an OBUF LUT that maps the neighborhood configuration β_{TS} or the reduced configuration β_{TS}′ to an index of the context. The encoder and/or decoder may entropy code (e.g., arithmetic code) the vertex information of the current TriSoup edge E based on the context.

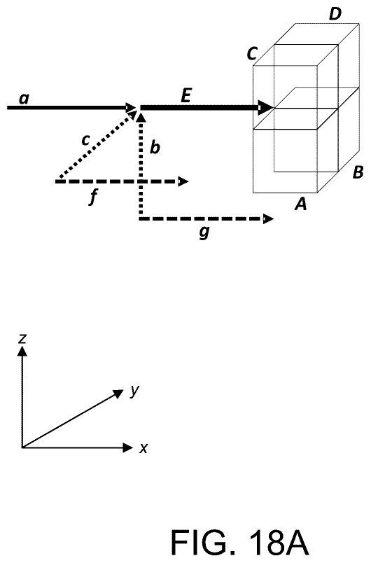

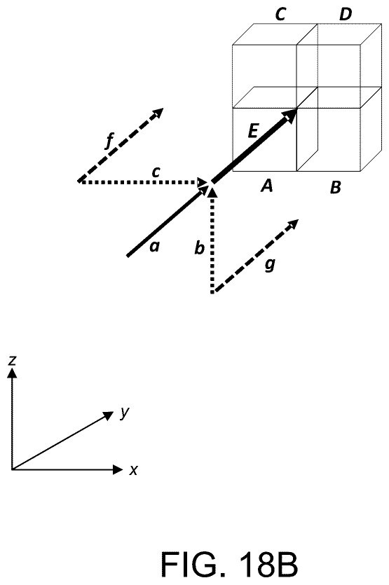

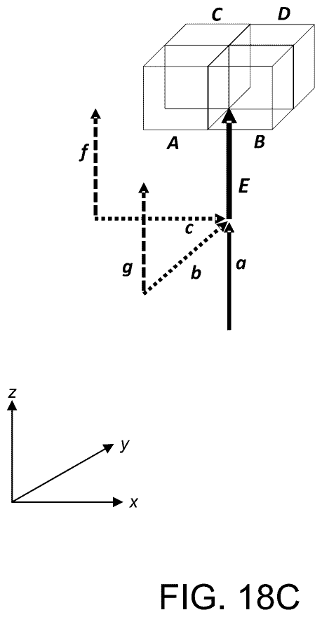

FIG. 18A, FIG. 18B, and FIG. 18C show a spatial topology comprising TriSoup edges and TriSoup nodes. The spatial topology may be a direction-independent spatial topology made of a combination of TriSoup edges and TriSoup nodes. FIG. 18A, FIG. 18B, and FIG. 18C show an addition to the edge-only direction-independent spatial-topology of FIG. 17A, FIG. 17B, and FIG. 17C. The four TriSoup nodes, labeled A, B, C, D, intersecting the end point of the current TriSoup edge E have been added. These four nodes are not drawn to scale for sake of clarity of the figures. These four nodes may correspond to nodes 1020 to 1023 in FIG. 10B. The labeling of the four nodes has been made for each direction such as to obtain direction independence of the topology of the spatial topology made up of the five edges a, b, c, f, g and of the four nodes A to D. By doing so, one or more symbols of the neighborhood configuration β_{TS} may be constructed from the direction-independent spatial topology made up of a combination of edges and nodes.

As described herein with respect to the various examples shown in FIGS. 11-18, a spatial (or sub-spatial) topology of edges, neighboring (e.g., defined relative to) a current TriSoup edge E, may include one or more already-coded edges which are used to determine one or more symbols of a neighborhood configuration β_{TS} of the current TriSoup edge E. The encoder and/or decoder may select a context (or probability model) for coding vertex information (e.g., a vertex presence flag (sₖ). The encoder and/or decoder may select a context (or probability model) for coding vertex information (e.g., a vertex presence flag (sₖ), for example, based on the neighborhood configuration β_{TS}. The encoder and/or decoder may select a context (or probability model) for coding vertex information (e.g., a vertex presence flag (sₖ) based on the neighborhood configuration β_{TS} and a vertex position (pₖ)) of the current TriSoup edge E if a vertex is present (i.e., the presence flag is equal to true). The encoder and/or decoder may select a context (or probability model) for coding vertex information (e.g., a vertex presence flag (sₖ) according to dynamic OBUF as discussed herein. The one or more symbols may correspond to (or represent) occupancy values (e.g., a vertex presence flag (sₖ)) of already-coded edges selected from the spatial topology of edges. The occupancy values may be binary values and represent binary states/information of already-coded edges. For example, an occupancy value, associated with an already-coded edge, may be a binary value representing the presence or the absence of a (TriSoup) vertex on the already-coded edge.

The disclosures provided herein improve the correlation between the neighborhood configuration β_{TS} of a current edge (e.g., a current TriSoup edge E) and the vertex information of the current edge E to be coded. Throughout these disclosures, the “neighborhood configuration” may be referred to as “neighborhood information”. The neighborhood information β_{TS} may include a portion β_{comb}, determined based on (e.g., as a result of) a linear combination of occupancy values associated with edges and/or cuboids neighboring the current edge, to entropy code vertex information of the current edge E in a point cloud. The linear combination may include coefficients (for the respective edges and/or cuboids), where each coefficient may have a sign based on a spatial position of the respective edge/cuboid relative to the current edge to improve and increase the correlation. Each of the coefficients may have a magnitude based on the spatial position relative to the current edge. The portion β_{comb} may result in improved correlation with respect to vertex information (e.g., a vertex presence and/or a vertex position) of the current edge, for example, by determining/configuring the sign and/or magnitude of each coefficient in the linear combination. One or more coefficients may be assigned a negative sign to reduce the impact or weight of one or more occupancy values, corresponding to the one or more coefficients, having in the linear combination associated with the portion β_{comb}. The improved correlation may allow the vertex information of the current edge being more effectively compressed using entropy coding, as described above.

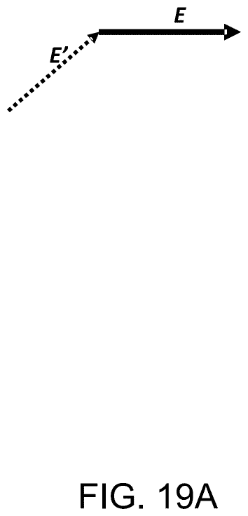

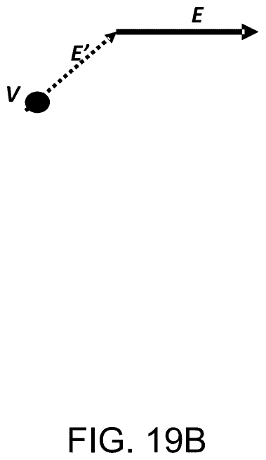

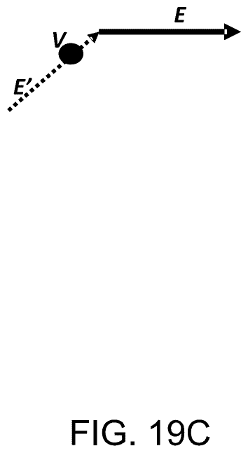

An occupancy value of an edge (e.g., a TriSoup edge) of a plurality of edges neighboring a current edge, may indicate vertex information of that edge. FIG. 19A, FIG. 19B, and FIG. 19C show examples of vertex information of a TriSoup edge E′ (referred to be below as edge E′) used for entropy coding vertex information a current TriSoup edge E (referred to below as edge E). For example, FIG. 19A shows that edge E′ has no vertex. Vertex information of edge E′ may include a vertex presence flag indicating an absence of a vertex, and may not include a vertex position because the vertex is absent. Each of FIGS. 19B and 19C shows that edge E′ has a vertex V. Vertex information of edge E′ may include a vertex presence flag indicating a presence of a vertex V, and may include a vertex position indicating a position of vertex V along edge E′.

An occupancy value of edge E′ may be a binary value indicating whether a vertex is present or absent along edge E′. The occupancy value may indicate whether a vertex, with a position within a threshold distance of the current edge E, is present on or along edge E′. The threshold distance may be between the position and an endpoint of the current edge E, for example, the endpoint that intersects edge E′. The threshold distance may be one half of a length of edge E′, one quarter of the length of edge E′, etc. The occupancy value of edge E′ in FIG. 19B may be a binary value indicating that no vertex V, with a position within the threshold distance of the current edge E, is present on edge E′.

An occupancy value of an edge E′ may be a non-binary value. The occupancy value of an edge E′ may be a non-binary value that is determined based on a presence/absence (s_{k′}) of a TriSoup vertex. The occupancy value of an edge E′ may be a non-binary value that is determined based on a presence/absence (s_{k′}) of a TriSoup vertex and the TriSoup vertex position (p_{k′}) if a vertex is present. The occupancy value may be a ternary value indicating both: whether a vertex (e.g., a TriSoup vertex V) is present on edge E′ and a relative position of the vertex with respect to the current edge E. The occupancy value may be equal to ‘0’, for example, if there is no vertex (e.g., s_{k′} is false) on an already-coded edge E′. The occupancy value may be equal to ‘1’, for example, if there is a vertex present (e.g., s_{k′} is true) on an already-coded edge E′ but the vertex does not have a position (p_{k′}) that is within a threshold distance relative to the current edge E. The occupancy value may be equal to ‘2’, for example, if there is a vertex present (e.g., s_{k′} is true) on an already-coded edge E′ and the vertex has a position (p_{k′}) that is within the threshold distance relative to the current edge E. For example, with respect to FIG. 19A, the edge E′ does not have a vertex present, and its occupancy value may be determined as occ(E′)=0. For example, with respect to FIG. 19B, edge E′ has a vertex with a vertex position that is far (e.g., outside of a threshold distance of) from the current edge E, and its occupancy value may be determined as occ(E′)=1. For example, with respect to FIG. 19C, edge E′ has a vertex with a vertex position that is near (e.g., within the threshold distance of) the current edge E, and its occupancy value may be determined as occ(E′)=2.

An occupancy value of a node (e.g., TriSoup node), corresponding to a neighboring cuboid relative the current edge E, may indicate an occupancy state of the neighboring cuboid. The cuboid may be neighboring the current edge E, for example, if it intersects the current edge E, as described herein with respect to FIG. 10. The occupancy value of the node and corresponding cuboid may be a binary value indicating (or representing) the presence or the absence of at least one point of the point cloud in the volume/cuboid associated with the neighboring node. The occupancy state of the node (or corresponding cuboid) may correspond to an occupancy bit associated with the node, as described herein with respect to FIG. 3. The node may be a leaf node of the occupancy tree.

A portion β_{comb} of neighborhood information β_{TS}, for coding vertex information of a current edge E, may be based on (e.g., be a result of) a linear combination of occupancy values ‘occ(.)’ associated with neighboring already-coded edges and/or cuboids. An occupancy value may be a binary value or a non-binary value, as discussed herein. An edge may be neighboring the current edge based on the edge belonging to at least one cuboid intersecting the current edge. A node (or corresponding cuboid) may be neighboring the current edge based on the node/cuboid intersecting the current edge.

A linear combination of the portion β_{comb} may be determined as a weighted sum

$${β}_{comb} = s + {\sum }_{el} {w}_{el} occ ( el )$$

over elements ‘el’ that may be either neighboring edges or neighboring cuboids relative to a current edge E whose vertex information is to be coded, where coefficients (i.e., also referred to as weights) We have respective magnitudes and respective signs. Each sign may be a positive sign or a negative sign. Each magnitude may be an integer. The occupancy values occ(el) of elements may be nonnegative binary (or non-binary) integers, as described herein. The linear combination may include an offset (or shift) ‘s’ that may be a constant value (e.g., a constant integer). The offset may be based on a direction of the current edge E. The offset may be a predetermined value. The offset may be a predetermined value, for example, based on a quantity of coefficients with a negative sign.

A portion β_{comb} may include a quantity (e.g., number) N_{bit} of bits of the neighborhood information β_{TS}. The quantity (e.g., number) N_{bit} of bits may correspond to a minimum quantity (e.g., number) of bits to represent a difference between the minimum possible value (e.g., min(β_{comb})) and the maximum possible value (e.g., max (β_{comb})) of β_{comb} over all possible occupancy values of elements in the linear combination. For example, the quantity (e.g., number) N_{bit} of bits may be determined as follows:

N_{bit}=log₂(1+max(β_{comb})−min(β_{comb}))

The offset ‘s’ may be determined such that the minimum possible value min(β_{comb}) is equal to zero, which avoids negative values of the part β_{comb}. The offset ‘s’ may be determined as a product of −1 and the minimum possible value. By using this offset ‘s’, the value β_{comb} may be copied bit per bit into the neighborhood information β_{TS} while minimizing its size N_{bit}.

A portion β_{comb} of the neighborhood information β_{TS} may include a symbol. This symbol may be determined, for example, based on a value resulting from the linear combination discussed herein. The symbol may be a binary value determined, for example, based on comparing a result of the linear combination of occupancy values ‘occ(.)’ to a threshold value ‘th’.

$${β}_{comb} = {\sum }_{el} {w}_{el} occ ( el ) > th$$

The portion β_{comb} may correspond to one bit of the neighborhood information β_{TS}. The neighborhood information β_{TS} may include two or more bits, and each of the bits may correspond to the comparison of a linear combination of occupancy values ‘occ(.)’ to a threshold. Each bit may correspond to a different linear combination of elements. Additionally, or alternatively, each bit may correspond to a different threshold. Comparing a value, which is based on the result of the linear combination, to a threshold may be advantageous. This comparison decreases the size of the portion β_{comb} to one bit, which may allow for using many linear combinations, in a same neighborhood information β_{TS}, involving different and complementary correlations.

Occupancy values of edges and/or cuboids (e.g., which may correspond to nodes of, e.g., an occupancy tree) may be aggregated in a linear combination. The occupancy values of edges and/or cuboids may be aggregated in a linear combination to determine the portion β_{comb}. The linear combination may include coefficients corresponding to the respective edges and/or cuboids. Each of the coefficients may have a sign based on a spatial position of the respective edge/cuboid relative to the current edge E. A first quantity (e.g., number) Nₛₜₐᵣₜ of already-coded occupied edges and nodes may belong to a spatial neighborhood of the current edge E. The first quantity (e.g., number) Nₛₜₐᵣₜ of already-coded occupied edges and nodes that intersect the starting point of the current edge E may be determined. A second quantity (e.g., number) N_{end} of already-coded occupied edges and nodes may belong to the spatial neighborhood. The second quantity (e.g., number) N_{end} of already-coded occupied edges and nodes that intersect the ending point of the current edge E may also be determined. An occupancy value of a k′-th edge may be determined or may indicate the edge is occupied with a vertex (V_{k′}). An occupancy value of a k′-th edge may indicate the edge is occupied with a vertex (V_{k′}), for example, with the presence flag (sk′) being true. The occupancy value of the edge may be determined or indicate the edge is occupied, for example, based on the position of a present vertex (V_{k′}) being within a threshold distance of the endpoint (e.g., the starting point or the ending point) of the current edge E intersecting the edge. The threshold distance may be one-half the edge length or one-fourth the edge length.

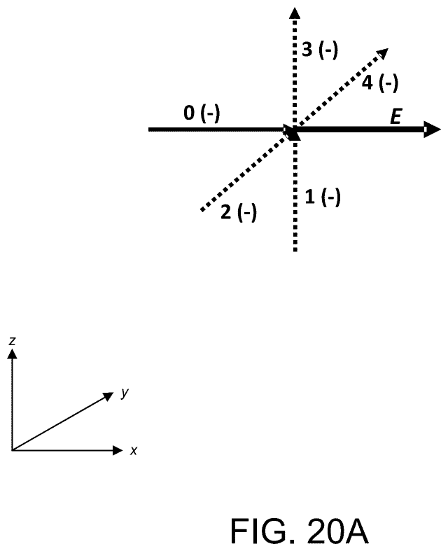

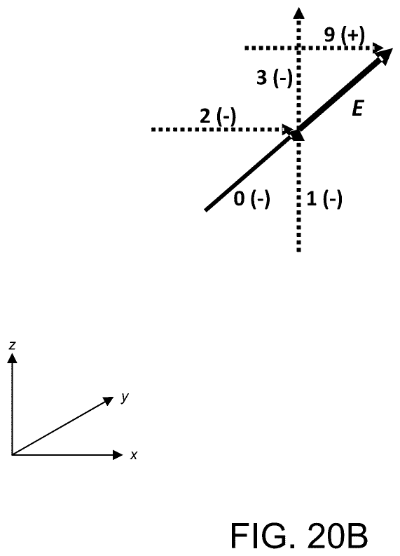

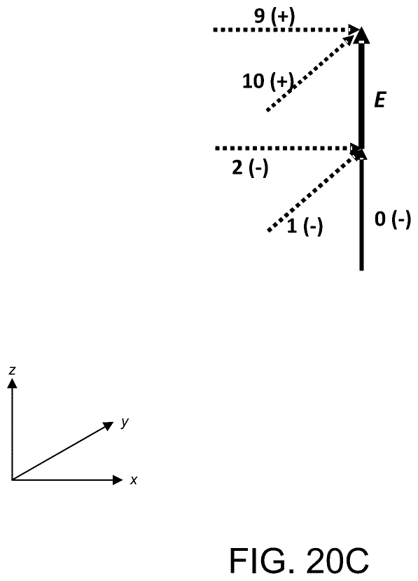

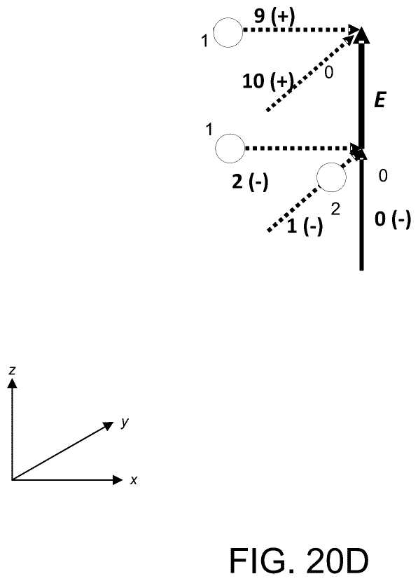

FIG. 20A, FIG. 20B, and FIG. 20C show examples of aggregating vertex information of a plurality of TriSoup edges. Vertex information of a plurality of TriSoup edges may be aggregated in a spatial topology of a current TriSoup edge E for entropy coding vertex information of the current TriSoup edge E. The first quantity (e.g., number) Nₛₜₐᵣₜ may be a sum of the occupancy values (e.g., 0=unoccupied, 1=occupied) of one or more available (e.g., already coded) edges of the edges 0 to 4. One or more available edges, of the edges 0 to 4, may depend on a direction of the current edge E. For example, as shown in FIG. 20B, Nₛₜₐᵣₜ may be the sum of the occupancy values of the four edges 0 to 3, for example, if the current edge E is in a direction (e.g., y direction) parallel to the y axis. The second quantity (e.g., number) N_{end} may be a sum of the occupancy values of one or more available (e.g., already coded) edges of the edges 9 and 10. The one or more available edges, of the edges 9 and 10, may depend on a direction of the current edge E. As shown in FIG. 20B, the second quantity (e.g., number) N_{end} may include an occupancy value of edge 9 because edge 10 may not be available for the current edge E in the y direction.

A high value for the first quantity (e.g., number) Nₛₜₐᵣₜ may be an indicator of the point cloud being likely located near the starting point of the current edge. A high value for the second quantity (e.g., number) N_{end} may be an indicator of the point cloud being likely located near the ending point of the current edge. Therefore, the magnitudes of the two quantities (e.g., numbers) Nₛₜₐᵣₜ and N_{end} may be correlated with the position (pₖ) of the vertex belonging to a current edge. The quantities (e.g., numbers) of Nₛₜₐᵣₜ and N_{end} may be used to construct a portion β_{comb} of the neighborhood information β_{TS} used by dynamic OBUF to code the bits (pₖ^{j}) representing the vertex position.

The difference ΔN=N_{end}−Nₛₜₐᵣₜ may be used to aggregate occupancy values of the edges and/or cuboids. A high value of ΔN may be an indicator of the vertex position (vₖ) being close to the ending point of the current edge. A low (negative) value of ΔN may be an indicator of the vertex position (vₖ) being close to the starting point of the current edge. The portion β_{comb} of the neighborhood information β_{TS} may be determined, for example, based on the difference ΔN. For the current edge E with a direction parallel to the z axis, as shown in FIG. 20C, the portion β_{comb} may be determined as a result of a linear combination of a plurality of edges (e.g., already-coded available edges 0, 1, 2, 9, and 10) neighboring the current edge E

β_{comb}=3+occ(‘10’)+occ(‘9’)−occ(‘2’)−occ(‘1)−occ(‘0’).

The linear combination may include a plurality of coefficients. The plurality of coefficients may correspond to the plurality of edges. Each of the plurality of coefficients may have a magnitude of 1 and a sign that is based on a spatial position of the respective edge. For example, the edges 9 and 10 may correspond to the second quantity (e.g., number) N_{end} of neighboring edges, which each of the edges 9 and 10 intersects the ending point of the current edge E and has a positive sign. The edges 2, 1, and 0 may correspond to the first quantity (e.g., number) Nₛₜₐᵣₜ of neighboring edges, which each of the edges 2, 1, and 0 intersects the starting point of the current edge and has a negative sign. In this example, the portion β_{comb} may be a nonnegative integer no greater than 5 whose size is N_{bit}=3 bits in the neighborhood information β_{TS}. This example shows the advantage of using negative coefficients Wₑₗ=−1.

For the current edge E with a direction parallel to the z axis as shown in FIG. 20D, the portion β_{comb} may be determined as a result of a linear combination of a plurality of edges (e.g., already-coded available edges 1, 2 and 9 with vertices, and edges 0 and 10 without vertices) neighboring the current edge E

β_{comb}=occ(‘10’)+occ(‘9’)−occ(‘2’)−occ(‘1)−occ(‘0’).

The linear combination may include a plurality of occupancy values. The plurality of occupancy values may correspond to the plurality of edges. Each of the occupancy values may have a magnitude and a sign that is based on a spatial position of the respective edge. As discussed in FIG. 19A, FIG. 19B and FIG. 19C, the occupancy value may be equal to ‘0’, for example, if there is no vertex on an already-coded edge. The occupancy value may be equal to ‘1’, for example, if there is a vertex present on an already-coded edge but the vertex does not have a position within a threshold distance relative to the current edge. The occupancy value may be equal to ‘2’, for example, if there is a vertex present on an already-coded edge and the vertex has a position within the threshold distance relative to the current edge. For example, the edges 9 and 10 may correspond to neighboring edges that each intersect the ending point of the current edge E and has a positive sign. The occupancy value corresponding to edge 9 may be ‘+1’ because the vertex on edge 9 is not within the threshold distance. The occupancy value corresponding to edge 10 may be ‘0’ because there is no vertex on edge 10. The edges 2, 1, and 0 may correspond to neighboring edges that each intersect the starting point of the current edge and has a negative sign. The occupancy value corresponding to edge 1 may be ‘2’ because the vertex on edge 1 is within the threshold distance. The occupancy value corresponding to edge 2 may be ‘1’ and the occupancy value corresponding to edge 0 may be ‘0.’ This example shows the portion β_{comb} may be determined as:

β_{comb}=0+1−1−2−0=−2.

A threshold value may be compared with the linear combination, e.g., the difference ΔN, to determine the portion β_{comb} of the neighborhood information β_{TS} as a binary symbol For example, the symbol of the portion part β_{comb} may indicate if ΔN>0.

β_{comb}=occ(‘10’)+occ(‘9’)−occ(‘2’)−occ(‘1)−occ(‘0’)>0

The β_{comb} as a binary symbol may correlate strongly with the first bit (e.g., the most significant bit) of the vertex position of a vertex present (or occupying) the current edge E. The first bit may indicate that the vertex belongs to a particular half of the current edge, and thus the first bit may be strongly correlated with the binary symbol. Although the magnitudes of the coefficients of the linear combinations corresponding to example portions β_{comb} have been shown as 1, the magnitudes may be another value (e.g., greater than 1). The current edge E is in a direction (e.g., x direction) parallel to the x axis as shown in FIG. 20A, and there may not be any already-coded edge neighboring the current edge E. The linear combination may be of neighboring edges and cuboids (corresponding to nodes), as described herein.

FIG. 21 shows an example of aggregating vertex information of a plurality of TriSoup edges. More specifically, FIG. 21 shows an example of aggregating vertex information of the plurality of TriSoup edges illustrated in FIG. 20A and occupancy states of a plurality of TriSoup nodes (and corresponding cuboids) for entropy coding vertex information of a current TriSoup edge E. As shown in FIG. 21, the available edges may include edges 0-4 that each intersect the starting point of the current edge E. As further shown in FIG. 21, the cuboids A-D may each intersect the ending point of the current edge E. The portion part β_{comb} may include a linear combination of occupancy values of corresponding elements including edges 0-4 and cuboids A-D:

$${β}_{comb} = s + {\sum }_{el = A , … , D} occ ( el ) - {\sum }_{el = 0 , … , 4} occ ( el )$$

The occupancy value occ(el) of edge elements may be non-binary. An occupancy value may be a ternary value. For example, ‘0’ may indicate that a vertex not present; ‘1’ may indicate that a vertex is present but far (e.g., a position exceeding a threshold distance relative to the current edge); ‘2’ may indicate that a vertex is present and near (e.g., a position within a threshold distance relative to the current edge). The coefficients of occupancy values for the edges and/or the coefficients occupancy values for the cuboids may be greater than 1, similar to non-binary occupancy values. The occupancy values of the cuboids A-D may be weighted by a parameter W to balance against the sum of occupancy values of edges as follows

$${β}_{comb} = s + W * {\sum }_{el = A , … , D} occ ( el ) - {\sum }_{el = 0 , … , 4} occ ( el )$$

Using a ternary occupancy values for the edges, the weighting parameter W may be equal to 2 such as to balance the total occupancy values of edges that may be as high as 5*2=10 relative to the total occupancy values of cuboids, which may be as high as W*4. Non-unitary weights (other than +1 or −1) may be used in the linear combination to obtain a balance between sets S of neighboring elements having different cardinalities #S and occupancy functions occ(.).

Coefficients of the linear combination, as described herein, may be determined by using a training algorithm to determine more optimal coefficients. A minimization algorithm may be used to find optimal parameters (e.g., coefficients wₑₗ and threshold value ‘th’) such as to minimize the conditional entropy H(sₖ, β_{comb}) or H(pₖ^{j}, β_{comb}) of edge information knowing the value of a binary part β_{comb} of the neighborhood information β_{TS}. The minimization algorithm may be used to find optimal parameters, for example, based on the portion β_{comb}:

$${β}_{comb} = {\sum }_{el} {w}_{el} occ ( el ) > th$$

Sample point clouds may be used to obtain occupancy values occ(el) and edge information sₖ or pₖ^{j} for a large quantity (e.g., number) of test current edges. Minimization algorithms (e.g., genetic algorithms or simulated annealing) may be used to obtain the optimal parameters. Obtained optimal parameters may be hardcoded into both point cloud encoder and decoder using lookup tables. Using these hardcoded parameters may lead to improved compression performance on point clouds having similar characteristics as the sample point clouds used to generate the parameters.

FIG. 22A shows an example method for encoding vertex information of a current edge. More specifically, FIG. 22A shows a flowchart 2200 of example method steps for encoding vertex information of a current edge. The current edge may be an edge (e.g., a TriSoup edge) of a cuboid comprising part of a point cloud. One or more steps of the example flowchart 2200 may be implemented by an encoder, such as encoder 114 as shown in FIG. 1).

At step 2202, the encoder may calculate a value based on a linear combination of a plurality of occupancy values with a plurality of respective coefficients. The plurality of occupancy values may indicate vertex information of a plurality of respective edges (e.g., TriSoup edges) neighboring a current edge (e.g., a current TriSoup edge). The plurality of coefficients may comprise a plurality of respective signs, where each of the respective signs is based on a spatial position of each edge of the plurality of respective edges relative to the current edge. Each edge (e.g., the current edge or each of the plurality of edges) has two endpoints including a starting point and an ending point, as shown in FIGS. 11-21. An edge may be oriented from its starting point to its ending point following the orientation of one of the three axes (i.e., x, y, or z axis) of the 3D space. Thus, each edge has a direction that indicates its orientation in one of the three axes of the 3D space.

A plurality of edges may belong to a spatial topology of edges, where each edge of the spatial topology of edges may be available for coding the current edge. The spatial topology of edges may be a neighborhood of already-coded edges corresponding to a direction of the current edge, as shown and described herein with respect to FIGS. 14A, 14B, 14C and also described herein with respect to FIGS. 15A, 15B, 15C and FIGS. 16A, 16B, 16C. Each of the plurality of edges (i.e., neighboring the current edge) may belong to at least one cuboid that intersects the current edge, for example, as described herein with respect to FIGS. 10A, 10B. Each of the plurality of edges may intersect one of the two endpoints of the current edge. Each of the edges may belong to at least one cuboid that intersects one of the two endpoints of the current edge.

Each of a plurality of edges may belong to a spatial topology of edges only including (or consisting of): an edge that is parallel to the current edge and that intersects the starting point of the current edge; and edges belonging to a same cuboid as the current edge.

A quantity of the plurality of edges may be independent of a direction of the current edge. For example, the possible directions in the x, y, and z axes may each correspond to 5 edges for coding current edge E, as shown in FIGS. 20A, 20B, 20C. Each of the plurality of signs may be further based on a direction of the current edge.

A plurality of coefficients may comprise a plurality of respective magnitudes, where each respective magnitude is based on a spatial position of each edge, of the plurality of respective edges, relative to the current edge. Each of the plurality of magnitudes may be further based on a direction of the current edge.

A spatial position of each edge may indicate a distance of the edge from the current edge. The spatial position of each edge may indicate which of the two endpoints of the current edge that the edge intersects. The two endpoints of the current edge may include the starting point of the current edge and the ending point of the current edge. Each sign of the plurality of signs may be based on the spatial position indicating whether each of the plurality of respective edges intersects the starting point or the ending point. An edge that intersects the starting point (of the current edge) has an occupancy value with a coefficient that may have a first sign (e.g., one of a positive sign or a negative sign). An edge that intersects the ending point has an occupancy value with a coefficient that may have a second sign opposite of the first sign. For each coefficient of the plurality of coefficients, a sign of the coefficient may be a positive sign, for example, based on (e.g., in response to) an edge, corresponding to the coefficient, intersecting the starting point of the two endpoints. For each coefficient of the plurality of coefficients, a sign of the coefficient may be a negative sign, for example, based on (e.g., in response) to the edge intersecting the ending point of the two endpoints (or vice versa in other examples).

Signs and/or the magnitudes of the coefficients of the linear combination may be predetermined. The signs and/or the magnitudes of the coefficients of the linear combination may be predetermined, for example, based on using a minimization algorithm (e.g., a genetic algorithm, simulated annealing, etc.) with respect to entropy encoding vertex information of edges of sample point clouds, which may be representative of the point cloud including the current edge whose vertex information is to be entropy encoded.

The encoder may determine the plurality of occupancy values of the plurality of respective edges belonging to a spatial topology of edges relative to a current edge, where each occupancy value of each available edge may indicate vertex information of the available edge. The spatial topology may include neighboring edges that each belong to at least one cuboid intersecting the current edge.

Vertex information of an edge (e.g., that is available or already-coded) may include a vertex presence flag indicating whether a vertex is present on the edge, e.g., as shown in FIG. 19A. The vertex information of the edge may include a vertex position indicating a position of the vertex on the edge, e.g., as shown in FIG. 19A, FIG. 19B, and FIG. 19C. Each occupancy value of the plurality of occupancy values may be based on vertex information of a respective edge of the plurality of edges. Each occupancy value may be a binary value indicating whether a vertex is present on the edge. Each occupancy value, based on the vertex presence flag, may be a binary value indicating whether a vertex is present on the edge.

Each occupancy value, based on the vertex presence flag and the vertex position (if a vertex is present), may be a binary value indicating whether a vertex is present with a position, on the respective edge, that is within a threshold distance of the current edge. The threshold distance may be one-half of a length of the edge. The threshold distance may be one-fourth of a length of the edge. The threshold distance may be between the position of the vertex and the endpoint of the current edge that intersects the edge.

Each occupancy value (of a respective edge) may include a value indicating: whether a vertex is present along the edge, and whether a position of the vertex, if present, is within the threshold distance of the current edge. The value may be a non-binary value. Each occupancy value may include a ternary value that includes (or consists of) one of: a first value (e.g., ‘0’) indicating an absence of the vertex, a second value (e.g., ‘1’) indicating that the vertex is present with the position being greater than the threshold distance, and/or a third value (e.g., ‘2’) indicating that the vertex is present with the position being within the threshold distance. A vertex located closer to the current edge may be weighted more heavily in the linear combination, for example, by including a non-binary value. Weighting a vertex located closer to the current edge more heavily in the linear combination may increase correlation with a presence of a vertex on the current edge and/or with a position of the vertex (if present) being closer to the endpoint of the current edge that intersects the edge.

A value (e.g., occupancy value) is calculated based on a sum of an offset and a result of the linear combination. The offset may be based on a direction of the current edge. The offset may be a predetermined value for each possible direction. The offset may be based on (or corresponds) to a quantity of the plurality of coefficients having a negative sign.

A linear combination may be extended to include occupancy values of nodes corresponding to respective cuboids that each intersect the current edge. The value may be calculated, for example, based on a sum of the linear combination and a second linear combination of a second plurality of occupancy values with a second plurality of respective coefficients. The second plurality of occupancy values may indicate a plurality of occupancy states of a plurality of respective cuboids intersecting the current edge. The plurality of occupancy states may be associated with a plurality of respective nodes corresponding to the plurality of respective cuboids. Each of the plurality of cuboids may intersect one of the two endpoints of the current edge. Each of the plurality of cuboids may intersect only the ending point of the two endpoints of the current edge. The plurality of nodes may correspond to a same level, in an occupancy tree, as a cuboid with the current edge as an edge.

A value (e.g., occupancy value) may be calculated based on the sum of the linear combination and the second linear combination. The value (e.g., occupancy value) may be calculated based on the sum of the linear combination and the second linear combination, for example, based on (e.g., after, in response to) each of the plurality of edges intersecting only the starting point of the two endpoints. The value may be calculated based on the sum of the linear combination and the second linear combination, for example, based on (e.g., in response to) the current edge being in a specific direction (e.g., in the x direction or along the x axis). Each of the plurality of cuboids may intersect only the ending point of the two endpoints of the current edge. The plurality of nodes may correspond to a same level, in an occupancy tree, as a cuboid with the current edge as an edge.

A second plurality of coefficients (of the second linear combination) may include a second plurality of respective signs. Each second respective sign may be based on a spatial position of each cuboid of the plurality of cuboids relative to the current edge. The spatial position of each cuboid may indicate a distance of the cuboid from the current edge. The spatial position of each cuboid may indicate which of the two endpoints the cuboid of the plurality of respective cuboids intersects.

A coefficient (corresponding to an occupancy value of the cuboid) may have a negative sign (or alternatively a positive sign). The coefficient (corresponding to an occupancy value of the cuboid) may have a negative sign (or alternatively a positive sign), for example, based on a cuboid intersecting the ending point of the two endpoints. A cuboid intersecting the starting point may be associated with a coefficient having an opposite sign relative to the sign of edges or cuboids intersecting the ending point. As shown in FIGS. 10A, 10B, 10C, the current edge may be an edge of (and therefore intersects) four cuboids; four cuboids may intersect the starting point of the current edge; and four cuboids may intersect the ending point of the current edge.

The second plurality of coefficients may comprise a second plurality of respective magnitudes. Each of the second plurality of respective magnitudes may be based on a spatial position of each cuboid, of the plurality of respective cuboids, relative to the current edge. Each of the second plurality of occupancy states may indicate whether each of the plurality of respective cuboids includes one or more points of a point cloud. An occupancy state may correspond to an occupancy bit, of an occupancy word, indicating occupancy of a respective (sub-)cuboid, as described above with respect to FIG. 3. The signs and/or the magnitudes of the coefficients of the second linear combination may be predetermined. The signs and/or the magnitudes of the coefficients of the second linear combination may be predetermined, for example based on using a minimization algorithm (e.g., a genetic algorithm, simulated annealing, etc.) with respect to entropy encoding vertex information of edges of sample point clouds. Vertex information of edges of sample point clouds may be representative of the point cloud including the current edge whose vertex information is to be entropy coded.

At step 2204, the encoder may determine one or more symbols of a neighborhood configuration of the current edge. The encoder may determine one or more symbols of a neighborhood configuration of the current edge, for example, based on a value (e.g., the value calculated in step 2202). The one or more symbols may include a symbol determined based on whether the value is greater than a threshold value. The threshold value may be zero. The threshold may be independent of a direction of the current edge. The threshold value may be based on (or corresponds to) a direction of the current edge. The symbol may be a binary symbol indicating whether the value is greater than the threshold value (e.g., a binary ‘1’ indicates the value is greater than the threshold value). Arithmetic coders may be utilized to increase compression efficiency of coded vertex information. Arithmetic coders may be utilized to increase compression efficiency of coded vertex information, for example, by binarizing aggregated vertex information of edges for encoding vertex information of the current edge.

At step 2206, the encoder may select, based on the neighborhood configuration, a context (e.g., a probability model) for encoding vertex information of the current edge. The vertex information of the current edge may include a vertex presence flag of the current edge. The vertex information of the current edge may include a vertex position of the current edge. The encoder may select the context/probability model for encoding the vertex information of the current edge. The encoder may select the context/probability model for encoding the vertex information of the current edge, for example, based on a lookup table (e.g., OBUF lookup table) that maps the neighborhood configuration to the context/probability model.

The encoder may select the context/probability model for encoding the vertex information of the current edge. The encoder may select the context/probability model for encoding the vertex information of the current edge, for example, based on a lookup table that maps only a subset of the symbols of the neighborhood configuration to the context/probability model. The subset of the symbols of the neighborhood configuration may be determined, for example, by using an OBUF dynamic reduction function with respect to the symbols of the neighborhood configuration. A quantity (e.g., number) of symbols in the subset may be increased. The quantity (e.g., number) of symbols in the subset may be increased, for example, based on a quantity (e.g., number) of coded edges with neighborhood information comprising the same subset of symbols. The encoder may further update the lookup table to map the subset of symbols of the neighborhood configuration to a different context/probability model based on the vertex information of the current edge.

At step 2208, the encoder may entropy encode (e.g., arithmetic encode) the vertex information of the current edge. The encoder may entropy encode (the vertex information of the current edge, for example, based on the context/probability model. The vertex information may be encoded using an arithmetic binary encoder similar to CABAC. Entropy encoding the vertex information may include entropy encoding a vertex presence flag of the current edge. Entropy encoding the vertex information may include entropy encoding a vertex position of the current edge. A symbol of a position of a vertex present on the current edge may be entropy encoded. A symbol of a position of a vertex present on the current edge may be entropy encoded, for example, based on the selected context/probability model. The symbol may correspond to a most significant bit of the position. Multiple symbols of a position of a vertex present on the current edge may be entropy encoded, for example, based on the selected context/probability model.

FIG. 22B shows an example method for decoding vertex information of a current edge. More specifically, FIG. 22B shows a flowchart 2250 of example method steps for decoding vertex information of a current edge. The current edge may be an edge (e.g., a TriSoup edge) of a cuboid comprising part of a point cloud. One or more steps of the example flowchart 2250 may be implemented by a decoder, such as decoder 120 as shown in FIG. 1).

At step 2252, the decoder may calculate a value based on a linear combination of a plurality of occupancy values with a plurality of respective coefficients. The plurality of occupancy values may indicate vertex information of a plurality of respective edges (e.g., TriSoup edges) neighboring a current edge (e.g., a current TriSoup edge). The plurality of coefficients may comprise a plurality of respective signs, where each of the respective signs is based on a spatial position of each edge of the plurality of respective edges relative to the current edge. Each edge (e.g., the current edge or each of the plurality of edges) has two endpoints including a starting point and an ending point, as shown in FIGS. 11-21. An edge may be oriented from its starting point to its ending point following the orientation of one of the three axes (i.e., x, y, or z axis) of the 3D space. Thus, each edge has a direction that indicates its orientation in one of the three axes of the 3D space.

A plurality of edges may belong to a spatial topology of edges, where each edge of the spatial topology of edges may be available for coding the current edge. The spatial topology of edges may be a neighborhood of already-coded edges corresponding to a direction of the current edge, as shown and described herein with respect to FIGS. 14A, 14B, 14C and also described herein with respect to FIGS. 15A, 15B, 15C and FIGS. 16A, 16B, 16C. Each of the plurality of edges (i.e., neighboring the current edge) may belong to at least one cuboid that intersects the current edge, for example, as described herein with respect to FIGS. 10A, 10B. Each of the plurality of edges may intersect one of the two endpoints of the current edge. Each of the edges may belong to at least one cuboid that intersects one of the two endpoints of the current edge.

Each of a plurality of edges may belong to a spatial topology of edges only including (or consisting of): an edge that is parallel to the current edge and that intersects the starting point of the current edge; and edges belonging to a same cuboid as the current edge.

A quantity of the plurality of edges may be independent of a direction of the current edge. For example, the possible directions in the x, y, and z axes may each correspond to 5 edges for coding current edge E, as shown in FIGS. 20A, 20B, 20C. Each of the plurality of signs may be further based on a direction of the current edge.

A plurality of coefficients may comprise a plurality of respective magnitudes, where each respective magnitude is based on a spatial position of each edge, of the plurality of respective edges, relative to the current edge. Each of the plurality of magnitudes may be further based on a direction of the current edge.

A spatial position of each edge may indicate a distance of the edge from the current edge. The spatial position of each edge may indicate which of the two endpoints of the current edge that the edge intersects. The two endpoints of the current edge may include the starting point of the current edge and the ending point of the current edge. Each sign of the plurality of signs may be based on the spatial position indicating whether each of the plurality of respective edges intersects the starting point or the ending point. An edge that intersects the starting point (of the current edge) has an occupancy value with a coefficient that may have a first sign (e.g., one of a positive sign or a negative sign). An edge that intersects the ending point has an occupancy value with a coefficient that may have a second sign opposite of the first sign. For each coefficient of the plurality of coefficients, a sign of the coefficient may be a positive sign, for example, based on (e.g., in response to) an edge, corresponding to the coefficient, intersecting the starting point of the two endpoints. For each coefficient of the plurality of coefficients, a sign of the coefficient may be a negative sign, for example, based on (e.g., in response) to the edge intersecting the ending point of the two endpoints (or vice versa in other examples).

Signs and/or the magnitudes of the coefficients of the linear combination may be predetermined. The signs and/or the magnitudes of the coefficients of the linear combination may be predetermined, for example, based on using a minimization algorithm (e.g., a genetic algorithm, simulated annealing, etc.) with respect to entropy decoding vertex information of edges of sample point clouds, which may be representative of the point cloud including the current edge whose vertex information is to be entropy decoded.

The decoder may determine the plurality of occupancy values of the plurality of respective edges belonging to a spatial topology of edges relative to a current edge, where each occupancy value of each available edge may indicate vertex information of the available edge. The spatial topology may include neighboring edges that each belong to at least one cuboid intersecting the current edge.

Vertex information of an edge (e.g., that is available or already-coded) may include a vertex presence flag indicating whether a vertex is present on the edge, e.g., as shown in FIG. 19A. The vertex information of the edge may include a vertex position indicating a position of the vertex on the edge, e.g., as shown in FIG. 19A, FIG. 19B, and FIG. 19C. Each occupancy value of the plurality of occupancy values may be based on vertex information of a respective edge of the plurality of edges. Each occupancy value may be a binary value indicating whether a vertex is present on the edge. Each occupancy value, based on the vertex presence flag, may be a binary value indicating whether a vertex is present on the edge.

Each occupancy value, based on the vertex presence flag and the vertex position (if a vertex is present), may be a binary value indicating whether a vertex is present with a position, on the respective edge, that is within a threshold distance of the current edge. The threshold distance may be one-half of a length of the edge. The threshold distance may be one-fourth of a length of the edge. The threshold distance may be between the position of the vertex and the endpoint of the current edge that intersects the edge.

Each occupancy value (of a respective edge) may include a value indicating: whether a vertex is present along the edge, and whether a position of the vertex, if present, is within the threshold distance of the current edge. The value may be a non-binary value. Each occupancy value may include a ternary value that includes (or consists of) one of: a first value (e.g., ‘0’) indicating an absence of the vertex, a second value (e.g., ‘1’) indicating that the vertex is present with the position being greater than the threshold distance, and/or a third value (e.g., ‘2’) indicating that the vertex is present with the position being within the threshold distance. A vertex located closer to the current edge may be weighted more heavily in the linear combination, for example, by including a non-binary value. Weighting a vertex located closer to the current edge more heavily in the linear combination may increase correlation with a presence of a vertex on the current edge and/or with a position of the vertex (if present) being closer to the endpoint of the current edge that intersects the edge.

A value (e.g., occupancy value) is calculated based on a sum of an offset and a result of the linear combination. The offset may be based on a direction of the current edge. The offset may be a predetermined value for each possible direction. The offset may be based on (or corresponds) to a quantity of the plurality of coefficients having a negative sign.

A linear combination may be extended to include occupancy values of nodes corresponding to respective cuboids that each intersect the current edge. The value may be calculated, for example, based on a sum of the linear combination and a second linear combination of a second plurality of occupancy values with a second plurality of respective coefficients. The second plurality of occupancy values may indicate a plurality of occupancy states of a plurality of respective cuboids intersecting the current edge. The plurality of occupancy states may be associated with a plurality of respective nodes corresponding to the plurality of respective cuboids. Each of the plurality of cuboids may intersect one of the two endpoints of the current edge. Each of the plurality of cuboids may intersect only the ending point of the two endpoints of the current edge. The plurality of nodes may correspond to a same level, in an occupancy tree, as a cuboid with the current edge as an edge.

A value (e.g., occupancy value) may be calculated based on the sum of the linear combination and the second linear combination. The value (e.g., occupancy value) may be calculated based on the sum of the linear combination and the second linear combination, for example, based on (e.g., after, in response to) each of the plurality of edges intersecting only the starting point of the two endpoints. The value may be calculated based on the sum of the linear combination and the second linear combination, for example, based on (e.g., in response to) the current edge being in a specific direction (e.g., in the x direction or along the x axis). Each of the plurality of cuboids may intersect only the ending point of the two endpoints of the current edge. The plurality of nodes may correspond to a same level, in an occupancy tree, as a cuboid with the current edge as an edge.

A second plurality of coefficients (of the second linear combination) may include a second plurality of respective signs. Each second respective sign may be based on a spatial position of each cuboid of the plurality of cuboids relative to the current edge. The spatial position of each cuboid may indicate a distance of the cuboid from the current edge. The spatial position of each cuboid may indicate which of the two endpoints the cuboid of the plurality of respective cuboids intersects.

A coefficient (corresponding to an occupancy value of the cuboid) may have a negative sign (or alternatively a positive sign). The coefficient (corresponding to an occupancy value of the cuboid) may have a negative sign (or alternatively a positive sign), for example, based on a cuboid intersecting the ending point of the two endpoints. A cuboid intersecting the starting point may be associated with a coefficient having an opposite sign relative to the sign of edges or cuboids intersecting the ending point. As shown in FIGS. 10A, 10B, 10C, the current edge may be an edge of (and therefore intersects) four cuboids; four cuboids may intersect the starting point of the current edge; and four cuboids may intersect the ending point of the current edge.

The second plurality of coefficients may comprise a second plurality of respective magnitudes. Each of the second plurality of respective magnitudes may be based on a spatial position of each cuboid, of the plurality of respective cuboids, relative to the current edge. Each of the second plurality of occupancy states may indicate whether each of the plurality of respective cuboids includes one or more points of a point cloud. An occupancy state may correspond to an occupancy bit, of an occupancy word, indicating occupancy of a respective (sub-)cuboid, as described above with respect to FIG. 3. The signs and/or the magnitudes of the coefficients of the second linear combination may be predetermined. The signs and/or the magnitudes of the coefficients of the second linear combination may be predetermined, for example based on using a minimization algorithm (e.g., a genetic algorithm, simulated annealing, etc.) with respect to entropy decoding vertex information of edges of sample point clouds. Vertex information of edges of sample point clouds may be representative of the point cloud including the current edge whose vertex information is to be entropy decoded.

At step 2254, the decoder may determine one or more symbols of a neighborhood configuration of the current edge. The decoder may determine one or more symbols of a neighborhood configuration of the current edge, for example, based on a value (e.g., the value calculated in step 2252). The one or more symbols may include a symbol determined based on whether the value is greater than a threshold value. The threshold value may be zero. The threshold may be independent of a direction of the current edge. The threshold value may be based on (or corresponds to) a direction of the current edge. The symbol may be a binary symbol indicating whether the value is greater than the threshold value (e.g., a binary ‘1’ indicates the value is greater than the threshold value). Arithmetic coders may be utilized to increase compression efficiency of coded vertex information. Arithmetic coders may be utilized to increase decompression efficiency of coded vertex information, for example, by binarizing aggregated vertex information of edges for decoding vertex information of the current edge.

At step 2256, the decoder may select, based on the neighborhood configuration, a context (e.g., a probability model) for decoding vertex information of the current edge. The vertex information of the current edge may include a vertex presence flag of the current edge. The vertex information of the current edge may include a vertex position of the current edge. The decoder may select the context/probability model for decoding the vertex information of the current edge. The decoder may select the context/probability model for decoding the vertex information of the current edge, for example, based on a lookup table (e.g., OBUF lookup table) that maps the neighborhood configuration to the context/probability model.

The decoder may select the context/probability model for decoding the vertex information of the current edge. The decoder may select the context/probability model for decoding the vertex information of the current edge, for example, based on a lookup table that maps only a subset of the symbols of the neighborhood configuration to the context/probability model. The subset of the symbols of the neighborhood configuration may be determined, for example, by using an OBUF dynamic reduction function with respect to the symbols of the neighborhood configuration. A quantity (e.g., number) of symbols in the subset may be increased. The quantity (e.g., number) of symbols in the subset may be increased, for example, based on a quantity (e.g., number) of coded edges with neighborhood information comprising the same subset of symbols. The decoder may further update the lookup table to map the subset of symbols of the neighborhood configuration to a different context/probability model based on the vertex information of the current edge.

At step 2258, the decoder may entropy decode (e.g., arithmetic decode) the vertex information of the current edge. The decoder may entropy decode (the vertex information of the current edge, for example, based on the context/probability model. The vertex information may be decoded using an arithmetic binary decoder similar to CABAC. Entropy decoding the vertex information may include entropy decoding a vertex presence flag of the current edge. Entropy decoding the vertex information may include entropy decoding a vertex position of the current edge. A symbol of a position of a vertex present on the current edge may be entropy decoded. A symbol of a position of a vertex present on the current edge may be entropy decoded, for example, based on the selected context/probability model. The symbol may correspond to a most significant bit of the position. Multiple symbols of a position of a vertex present on the current edge may be entropy decoded, for example, based on the selected context/probability model.

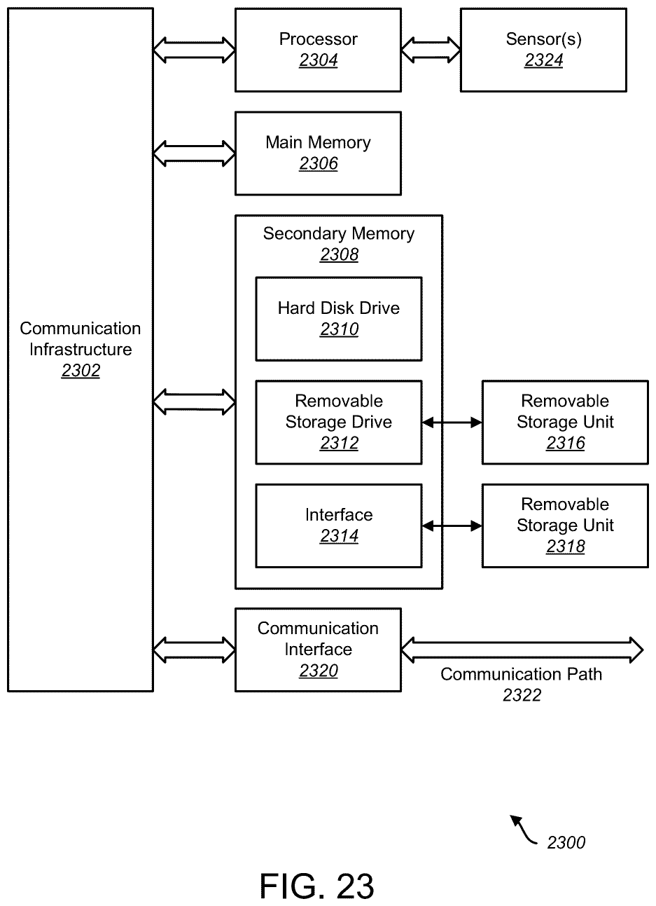

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 2300 is shown in FIG. 23. Blocks depicted in the figures above, such as the blocks in FIG. 1, may execute on one or more computer systems 2300. Furthermore, each of the steps of the flowchart(s) (e.g., flowchart in FIG. 22A and FIG. 22B) depicted in this disclosure may be implemented on one or more computer systems 2300. The computer systems 2300 may be interconnected by one or more networks to form a cluster of computer systems that may act as a single pool of seamless resources if more than one computer system 2300 is used to implement embodiments of the present disclosure, The interconnected computer systems 2300 may form a “cloud” of computers.

Computer system 2300 includes one or more processors, such as processor 2304. Processor 2304 may be, for example, a special purpose processor, general purpose processor, microprocessor, or digital signal processor. Processor 2304 may be connected to a communication infrastructure 2302 (for example, a bus or network). Computer system 2300 may also include a main memory 2306, such as random access memory (RAM), and may also include a secondary memory 2308.

Secondary memory 2308 may include, for example, a hard disk drive 2310 and/or a removable storage drive 2312, representing a magnetic tape drive, an optical disk drive, or the like. Removable storage drive 2312 may read from and/or write to a removable storage unit 2316 in a well-known manner. Removable storage unit 2316 represents a magnetic tape, optical disk, or the like, which is read by and written to by removable storage drive 2312. As will be appreciated by persons skilled in the relevant art(s), removable storage unit 2316 includes a computer usable storage medium having stored therein computer software and/or data.

Secondary memory 2308 may include other similar means for allowing computer programs or other instructions to be loaded into computer system 2300. Such means may include, for example, a removable storage unit 2318 and an interface 2314. Examples of such means may include a program cartridge and cartridge interface (such as that found in video game devices), a removable memory chip (such as an EPROM or PROM) and associated socket, a thumb drive and USB port, and other removable storage units 2318 and interfaces 2314 which allow software and data to be transferred from removable storage unit 2318 to computer system 2300.

Computer system 2300 may also include a communications interface 2320. Communications interface 2320 allows software and data to be transferred between computer system 2300 and external devices. Examples of communications interface 2320 may include a modem, a network interface (such as an Ethernet card), a communications port, etc. Software and data transferred via communications interface 2320 are in the form of signals which may be electronic, electromagnetic, optical, or other signals capable of being received by communications interface 2320. These signals are provided to communications interface 2320 via a communications path 2322. Communications path 2322 carries signals and may be implemented using wire or cable, fiber optics, a phone line, a cellular phone link, an RF link, and other communications channels.

Computer system 2300 may also include one or more sensor(s) 2324. Sensor(s) 2324 may measure or detect one or more physical quantities and convert the measured or detected physical quantities into an electrical signal in digital and/or analog form. For example, sensor(s) 2324 may include an eye tracking sensor to track the eye movement of a user. Based on the eye movement of a user, a display of a point cloud may be updated. In another example, sensor(s) 2324 may include a head tracking sensor to the track the head movement of a user. Based on the head movement of a user, a display of a point cloud may be updated. In yet another example, sensor(s) 2324 may include a camera sensor for taking photographs and/or a 3D scanning device, like a laser scanning, structured light scanning, and/or modulated light scanning device. 3D scanning devices may obtain geometry information by moving one or more laser heads, structured light, and/or modulated light cameras relative to the object or scene being scanned. The geometry information may be used to construct a point cloud.

As used herein, the terms “computer program medium” and “computer readable medium” are used to refer to tangible storage media, such as removable storage units 2316 and 2318 or a hard disk installed in hard disk drive 2310. These computer program products are means for providing software to computer system 2300. Computer programs (also called computer control logic) may be stored in main memory 2306 and/or secondary memory 2308. Computer programs may also be received via communications interface 2320. Such computer programs, if executed, enable the computer system 2300 to implement the present disclosure as discussed herein. In particular, the computer programs, if executed, enable processor 2304 to implement the processes of the present disclosure, such as any of the methods described herein. Accordingly, such computer programs represent controllers of the computer system 2300.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the relevant art(s).

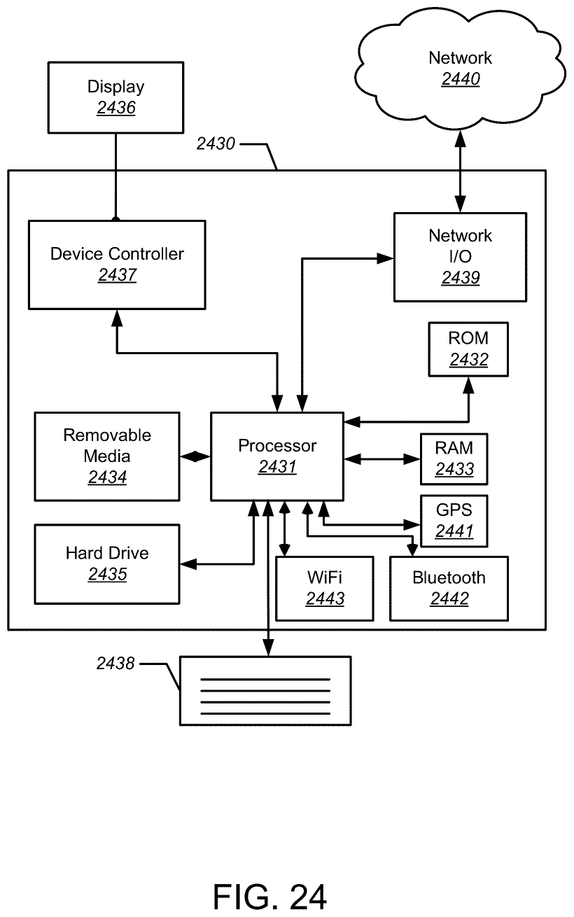

FIG. 24 shows example elements of a computing device that may be used to implement any of the various devices described herein, including, for example, a source device (e.g., 102), an encoder (e.g., 114), a destination device (e.g., 106), a decoder (e.g., 120), and/or any computing device described herein. The computing device 2430 may include one or more processors 2431, which may execute instructions stored in the random-access memory (RAM) 2433, the removable media 2434 (e.g., a Universal Serial Bus (USB) drive, compact disc (CD) or digital versatile disc (DVD), or floppy disk drive), or any other desired storage medium. Instructions may also be stored in an attached (or internal) hard drive 2435. The computing device 2430 may also include a security processor (not shown), which may execute instructions of one or more computer programs to monitor the processes executing on the processor 2431 and any process that requests access to any hardware and/or software components of the computing device 2430 (e.g., ROM 2432, RAM 2433, the removable media 2434, the hard drive 2435, the device controller 2437, a network interface 2439, a GPS 2441, a Bluetooth interface 2442, a Wi-Fi interface 2443, etc.). The computing device 2430 may include one or more output devices, such as the display 2436 (e.g., a screen, a display device, a monitor, a television, etc.), and may include one or more output device controllers 2437, such as a video processor. There may also be one or more user input devices 2438, such as a remote control, keyboard, mouse, touch screen, microphone, etc. The computing device 2430 may also include one or more network interfaces, such as a network interface 2439, which may be a wired interface, a wireless interface, or a combination of the two. The network interface 2439 may provide an interface for the computing device 2430 to communicate with a network 2440 (e.g., a RAN, or any other network). The network interface 2439 may include a modem (e.g., a cable modem), and the external network 2440 may include communication links, an external network, an in-home network, a provider's wireless, coaxial, fiber, or hybrid fiber/coaxial distribution system (e.g., a DOCSIS network), or any other desired network. Additionally, the computing device 2430 may include a location-detecting device, such as a global positioning system (GPS) microprocessor 2441, which may be configured to receive and process global positioning signals and determine, with possible assistance from an external server and antenna, a geographic position of the computing device 2430.

The example in FIG. 24 may be a hardware configuration, although the components shown may be implemented as software as well. Modifications may be made to add, remove, combine, divide, etc. components of the computing device 2430 as desired. Additionally, the components may be implemented using basic computing devices and components, and the same components (e.g., processor 2431, ROM storage 2432, display 2436, etc.) may be used to implement any of the other computing devices and components described herein. For example, the various components described herein may be implemented using computing devices having components such as a processor executing computer-executable instructions stored on a computer-readable medium, as shown in FIG. 24. Some or all of the entities described herein may be software based, and may co-exist in a common physical platform (e.g., a requesting entity may be a separate software process and program from a dependent entity, both of which may be executed as software on a common computing device).

A computing device may perform a method comprising multiple operations. A computing device may calculate a value based on a linear combination of first occupancy values with first coefficients, wherein: the first occupancy values indicate vertex information of edges neighboring a current edge; and the first coefficients comprise signs based on spatial positions of the edges, corresponding to the first coefficients, relative to the current edge. The computing device may select, based on a neighborhood configuration associated with the value, a context associated with coding vertex information of the current edge; and may code, based on the context, the vertex information of the current edge. The computing device may calculate the value, wherein the calculating the value may comprise: calculating a sum of: an offset associated with a direction of the current edge; and a result of the linear combination; wherein calculating the value may comprise: calculating a sum of: an offset associated with a quantity of the plurality of first coefficients having a negative sign; and a result of the linear combination; wherein calculating the value may comprise: calculating the value based on a sum of: the linear combination of the first occupancy values with the first coefficients; and a second linear combination of second occupancy values with second coefficients, wherein the second occupancy values may indicate occupancy states of respective cuboids intersecting the current edge, wherein: each coefficient, of the first coefficients, may comprises a magnitudes; and each magnitude may be based on a spatial position of an edge, of the edges, relative to the current edge; wherein: each of the signs may be further based on a direction of the current edge; and each of the magnitudes may be further based on the direction of the current edge; wherein the coding the vertex information of the current edge may comprise: coding, based on the context, a symbol of a vertex position present on the current edge; wherein the vertex information of the current edge may comprise at least one of: a vertex presence flag of the current edge; or the vertex position present on the current edge; wherein the selecting the context may comprise: based on an association between the neighborhood configuration and the context, selecting the context for coding the vertex information of the current edge; wherein each occupancy value, of the occupancy values, may be based on vertex information of a respective edge of the edges; wherein each of the edges may belong to a spatial topology of edges comprising: an edge being parallel to the current edge and intersecting a starting point of the current edge; and the edges belonging to a same cuboid as the current edge; wherein a quantity of the edges may be independent of a direction of the current edge; wherein the each occupancy value may comprise a binary value indicating whether a vertex is present on the edge; wherein the vertex information of each of the edges may comprise a vertex presence flag indicating whether a vertex is present on the corresponding edge; wherein the value may be further based on a sum in response to the edges each intersecting a starting point of two endpoints; wherein the second coefficients may comprise second signs, and wherein each of the second signs may be based on a spatial position of each cuboid of cuboids relative to the current edge; wherein the spatial position may indicate which the two endpoints associated with each cuboid of the plurality of respective cuboids intersect; wherein each of the second occupancy states may indicate whether each of the respective cuboids includes one or more points of a point cloud; wherein the current edge may be associated with a cuboid comprising part of a point cloud; wherein the threshold distance may be one of: one half of a length of the edge; or one fourth of a length of the edge; wherein the each occupancy value may comprise a value indicating: whether a vertex may be present along the edge; and whether a position of the vertex, if present, may be within a threshold distance of the current edge; wherein the each occupancy value may comprise a ternary value that includes (or consists of) one of: a first value indicating an absence of the vertex; a second value indicating the vertex is present with the position being within the threshold distance; or a third value indicating the vertex is present with the position being greater than the threshold distance; wherein the cuboids each may intersect only the ending point of the two endpoints; wherein the selecting may further comprise: selecting, based on a lookup table that maps only a subset of the symbols of the neighborhood configuration to the context, the context for coding the vertex information of the current edge. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to decode the vertex information of the current edge. A computer-readable medium may store instructions that, when executed, cause performance of the described method, additional operations and/or include the additional elements.

A computing device may perform a method comprising multiple operations. The computing device may calculate a value based on a linear combination of: occupancy values indicating vertex information of edges neighboring a current edge; and coefficients comprising signs based on spatial positions of the edges, corresponding to the first coefficients, relative to the current edge. The computing device may determine, based on the value, one or more symbols of a neighborhood configuration of the current edge. The computing device may code, based on a context associated with the neighborhood configuration, vertex information of the current edge. The computing device may, based on a mapping of a subset of the one or more symbols of the neighborhood configuration to the context, select the context for coding the vertex information of the current edge. The computing device may update, based on the vertex information of the current edge, the mapping to associate the subset of the one or more symbols of the neighborhood configuration with a different context. The computing device may, based on a quantity of coded edges with neighborhood information comprising the same subset of the one or more symbols, increase a quantity of the subset of the one or more symbols, wherein determining the one or more symbols may comprise: determining at least one symbol, of the one or more symbols, based on whether the value is greater than a threshold value; wherein the threshold value may be zero; wherein the threshold value may be independent of a direction of the current edge; wherein the threshold value may be based on a direction of the current edge; wherein the symbol may be a binary symbol indicating whether the value is greater than the threshold value; wherein each occupancy value of the occupancy values may comprises a binary value indicating at least one of: whether a vertex may be present with a position on a respective edge; or whether a vertex may be present within a threshold distance of the current edge; wherein the each occupancy value may comprise a binary value indicating whether a vertex may be present on the edge; wherein the vertex information of each of the edges may comprise a vertex presence flag indicating whether a vertex is present on the corresponding edge; wherein the value may further be based on a sum in response to the edges each intersecting a starting point of two endpoints; wherein the second coefficients comprise second signs, and wherein each of the second signs is based on a spatial position of each cuboid of cuboids relative to the current edge; wherein the spatial position may indicate which the two endpoints associated with each cuboid of the plurality of respective cuboids intersect; wherein each of the second occupancy states may indicate whether each of the respective cuboids may include one or more points of a point cloud; wherein the current edge may be associated with a cuboid comprising part of a point cloud; wherein the threshold distance may be one of: one half of a length of the edge; or one fourth of a length of the edge; wherein the each occupancy value may comprises a value indicating: whether a vertex may be present along the edge; and whether a position of the vertex, if present, may be within a threshold distance of the current edge; wherein the each occupancy value may comprise a ternary value that includes (or consists of) one of: a first value indicating an absence of the vertex; a second value indicating the vertex may be present with the position being within the threshold distance; or a third value indicating the vertex may be present with the position being greater than the threshold distance; wherein the cuboids each may intersect only the ending point of the two endpoints; wherein the selecting may further comprise: selecting, based on a lookup table that may map only a subset of the symbols of the neighborhood configuration to the context, the context for coding the vertex information of the current edge. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to decode the vertex information of the current edge. A computer-readable medium may store instructions that, when executed, cause performance of the described method, additional operations and/or include the additional elements.

A computing device may perform a method comprising multiple operations. The computing device may calculate a value as a sum of an offset and a linear combination, wherein: the offset may be based on a direction of a current edge; and the linear combination may be based on neighboring edges intersecting at least one of two endpoints of the current edge; determining, based on the value, a symbol of a neighborhood configuration of the current edge. The computing device may select, based on the neighborhood configuration, a context associated with coding vertex information of the current edge. The computing device may code, based on the context, the vertex information of the current edge. The computing device may calculate the linear combination based on signs, wherein: the two endpoints of the current edge may comprise a starting point and an ending point; and each of the signs may be based on whether each of the neighboring edges intersects the starting point or the ending point, wherein each of the signs may comprise: a positive sign indicating that at least one of the neighboring edges may intersect the starting point; or a negative sign indicating that at least one of the neighboring edges may intersect the ending point, wherein: each of the neighboring edges may be associated with at least one cuboid intersecting the current edge; and the at least one cuboid may intersect at least one of the two endpoints of the current edge; wherein a spatial position of the at least one cuboid may indicate whether the at least one cuboid may intersect one of the two endpoints of the current edge, wherein the each occupancy value may comprise a binary value indicating whether a vertex is present on the edge; wherein the vertex information of each of the edges may comprise a vertex presence flag indicating whether a vertex may be present on the corresponding edge; wherein the value may be further based on a sum in response to the edges each intersecting a starting point of two endpoints; wherein the second coefficients may comprise second signs, and wherein each of the second signs may be based on a spatial position of each cuboid of cuboids relative to the current edge; wherein the spatial position may indicate which the two endpoints associated with each cuboid of the plurality of respective cuboids intersect; wherein each of the second occupancy states may indicates whether each of the respective cuboids includes one or more points of a point cloud; wherein the current edge is associated with a cuboid comprising part of a point cloud; wherein the threshold distance may be one of: one half of a length of the edge; or one fourth of a length of the edge; wherein the each occupancy value may comprise a value indicating: whether a vertex may be present along the edge; and whether a position of the vertex, if present, may be within a threshold distance of the current edge; wherein the each occupancy value may comprise a ternary value that may comprise one of: a first value indicating an absence of the vertex; a second value indicating the vertex may be present with the position being within the threshold distance; or a third value indicating the vertex may be present with the position being greater than the threshold distance; wherein the cuboids each may intersect only the ending point of the two endpoints; wherein the selecting further may comprise: selecting, based on a lookup table that may map only a subset of the symbols of the neighborhood configuration to the context, the context for coding the vertex information of the current edge. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to decode the vertex information of the current edge. A computer-readable medium may store instructions that, when executed, cause performance of the described method, additional operations and/or include the additional elements.

One or more examples herein may be described as a process which may be depicted as a flowchart, a flow diagram, a data flow diagram, a structure diagram, and/or a block diagram. Although a flowchart may describe operations as a sequential process, one or more of the operations may be performed in parallel or concurrently. The order of the operations shown may be re-arranged. A process may be terminated when its operations are completed, but could have additional steps not shown in a figure. A process may correspond to a method, a function, a procedure, a subroutine, a subprogram, etc. If a process corresponds to a function, its termination may correspond to a return of the function to the calling function or the main function.

Operations described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks. Features of the disclosure may be implemented in hardware using, for example, hardware components such as application-specific integrated circuits (ASICs) and gate arrays. Implementation of a hardware state machine to perform the functions described herein will also be apparent to persons skilled in the art.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein. Computer-readable medium may comprise, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

A non-transitory tangible computer readable media may comprise instructions executable by one or more processors configured to cause operations described herein. An article of manufacture may comprise a non-transitory tangible computer readable machine-accessible medium having instructions encoded thereon for enabling programmable hardware to cause a device (e.g., an encoder, a decoder, a transmitter, a receiver, and the like) to allow operations described herein. The device, or one or more devices such as in a system, may include one or more processors, memory, interfaces, and/or the like.

Communications described herein may be determined, generated, sent, and/or received using any quantity of messages, information elements, fields, parameters, values, indications, information, bits, and/or the like. While one or more examples may be described herein using any of the terms/phrases message, information element, field, parameter, value, indication, information, bit(s), and/or the like, one skilled in the art understands that such communications may be performed using any one or more of these terms, including other such terms. For example, one or more parameters, fields, and/or information elements (IEs), may comprise one or more information objects, values, and/or any other information. An information object may comprise one or more other objects. At least some (or all) parameters, fields, IEs, and/or the like may be used and can be interchangeable depending on the context. If a meaning or definition is given, such meaning or definition controls.

One or more elements in examples described herein may be implemented as modules. A module may be an element that performs a defined function and/or that has a defined interface to other elements. The modules may be implemented in hardware, software in combination with hardware, firmware, wetware (e.g., hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and/or complex programmable logic devices (CPLDs). Computers, microcontrollers and/or microprocessors may be programmed using languages such as assembly, C, C++ or the like. FPGAs, ASICs and CPLDs are often programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

One or more of the operations described herein may be conditional. For example, one or more operations may be performed if certain criteria are met, such as in computing device, a communication device, an encoder, a decoder, a network, a combination of the above, and/or the like. Example criteria may be based on one or more conditions such as device configurations, traffic load, initial system set up, packet sizes, traffic characteristics, a combination of the above, and/or the like. If the one or more criteria are met, various examples may be used. It may be possible to implement any portion of the examples described herein in any order and based on any condition.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

What is claimed is:

1. A method comprising:
calculating a value based on a linear combination of:
first occupancy values indicating vertex information of edges neighboring a current edge associated with a video frame; and
first coefficients comprising signs based on spatial positions of the edges, corresponding to the first coefficients, relative to the current edge;
selecting, based on a neighborhood configuration associated with the value, a context associated with coding vertex information of the current edge; and
coding, based on the context, the vertex information of the current edge.

2. The method of claim 1, wherein calculating the value comprises:
calculating a sum of:
an offset associated with a direction of the current edge; and
a result of the linear combination.

3. The method of claim 1, wherein calculating the value comprises:
calculating a sum of:
an offset associated with a quantity of the plurality of first coefficients having a negative sign; and
a result of the linear combination.

4. The method of claim 1, wherein calculating the value comprises:
calculating the value based on a sum of:
the linear combination of the first occupancy values with the first coefficients; and
a second linear combination of second occupancy values with second coefficients,
wherein the second occupancy values indicate occupancy states of respective cuboids intersecting the current edge.

5. The method of claim 1, wherein:
each coefficient, of the first coefficients, comprises a magnitude; and
each magnitude is based on a spatial position of an edge, of the edges, relative to the current edge.

6. The method of claim 5, wherein:
each of the signs is further based on a direction of the current edge; and
each of the magnitudes is further based on the direction of the current edge.

7. The method of claim 1, wherein the coding the vertex information of the current edge comprises:
coding, based on the context, a symbol of a vertex position present on the current edge.

8. The method of claim 7, wherein the vertex information of the current edge comprises at least one of:
a vertex presence flag of the current edge; or
the vertex position present on the current edge.

9. The method of claim 1, wherein the selecting the context comprises:
based on an association between the neighborhood configuration and the context, selecting the context for coding the vertex information of the current edge.

10. A method comprising:
calculating a value based on a linear combination of:
occupancy values indicating vertex information of edges neighboring a current edge associated with a video frame; and
coefficients comprising signs based on spatial positions of the edges, corresponding to the first coefficients, relative to the current edge;
determining, based on the value, one or more symbols of a neighborhood configuration of the current edge; and
coding, based on a context associated with the neighborhood configuration, vertex information of the current edge.

11. The method of claim 10, further comprising:
based on a mapping of a subset of the one or more symbols of the neighborhood configuration to the context, selecting the context for coding the vertex information of the current edge.

12. The method of claim 11, further comprising:
updating, based on the vertex information of the current edge, the mapping to associate the subset of the one or more symbols of the neighborhood configuration with a different context.

13. The method of claim 11, further comprising:
based on a quantity of coded edges with neighborhood information, increasing a quantity of the subset of the one or more symbols, wherein the neighborhood information comprises the same subset of the one or more symbols.

14. The method of claim 10, wherein determining the one or more symbols comprises:
determining at least one symbol, of the one or more symbols, based on whether the value is greater than a threshold value.

15. The method of claim 10, wherein each occupancy value of the occupancy values comprises a binary value indicating at least one of:
whether a vertex is present with a position on a respective edge; or
whether a vertex is present within a threshold distance of the current edge.

16. A method comprising:
calculating a value as a sum of:
an offset based on a direction of a current edge associated with a video frame; and
a linear combination based on neighboring edges intersecting at least one of two endpoints of the current edge;
determining, based on the value, a symbol of a neighborhood configuration of the current edge;
selecting, based on the neighborhood configuration, a context associated with coding vertex information of the current edge; and
coding, based on the context, the vertex information of the current edge.

17. The method of claim 16, further comprising:
calculating the linear combination based on signs, wherein:
the two endpoints of the current edge comprise a starting point and an ending point; and
each of the signs is based on whether each of the neighboring edges intersects the starting point or the ending point.

18. The method of claim 17, wherein each of the signs comprises:
a positive sign indicating that at least one of the neighboring edges intersects the starting point; or
a negative sign indicating that at least one of the neighboring edges intersects the ending point.

19. The method of claim 16, wherein:
each of the neighboring edges is associated with at least one cuboid intersecting the current edge; and
the at least one cuboid intersects at least one of the two endpoints of the current edge.

20. The method of claim 19, wherein a spatial position of the at least one cuboid indicates whether the at least one cuboid intersects one of the two endpoints of the current edge.
